(19) United States
(12) Patent Application Publication
(10) Pub. No.: US 2025/0326237 A1
(43) Pub. Date: Oct. 23, 2025

(54) RECORDING DEVICE

(71) Applicant: SEIKO EPSON CORPORATION, TOKYO (JP)

(72) Inventor: Takuto TANAKA, SHIOJIRI-SHI (JP)

(21) Appl. No.: 19/186,780

(22) Filed: Apr. 23, 2025

(30) Foreign Application Priority Data
Apr. 23, 2024 (JP) 2024-069967

(51) Int. Cl. B41J 25/308; B41J 2/165; B41J 29/393

(52) U.S. Cl. CPC B41J 25/3082; B41J 2/16505; B41J 2/16535; B41J 29/393

(57) ABSTRACT

A recording device includes a movement mechanism that moves a recording section along a movement direction between a recording position where the recording section records on a medium and a retreat position where the recording section is retreated from the recording position; a positioning section that determines a position of the recording section in the movement direction as a positioning position; and a pressing unit that, in a state where a part of the recording section is in contact with the positioning section, presses the recording section so as to cancel moment generated in the recording section by force received from the positioning section and the movement mechanism, wherein the pressing unit includes a first advancing and retreating member that is provided independently of the recording section and that is configured to advance and retreat with respect to the recording section, a first pressing member that is provided independently of the recording section and that presses the first advancing and retreating member toward the recording section, a second advancing and retreating member that is provided in the recording section and that is configured to advance and retreat with respect to the first advancing and retreating member, and a second pressing member that is provided in the recording section and that presses the second advancing and retreating member toward the first advancing and retreating member.

The present application is based on, and claims priority from JP Application Serial Number 2024-069967, filed Apr. 23, 2024, the disclosure of which is hereby incorporated by reference herein in its entirety.

### BACKGROUND

### 1. Technical Field

The present disclosure relates to a recording device that records on a medium.

### 2. Related Art

JP-A-2023-076882 discloses a recording device in which a head unit including a recording head is configured to be movable between a recording position and a retreat position. In this recording device, the recording position is determined by abutting a part of the head unit against a positioning section. In the head unit, a moment of rotation is generated by a force applied to the head unit by a movement mechanism that moves the head unit and a reaction force that the head unit receives from the positioning section. Since this moment makes a posture of the head unit unstable, the recording device described in JP-A-2023-076882 is provided with a unit-pressing unit for applying a force to the head unit in a direction to cancel the rotation of the head unit when the head unit is at the recording position. The unit-pressing unit presses the head unit in a direction intersecting a movement direction of the head unit.

In JP-A-2023-076882, the unit-pressing unit is composed of a portion on a head unit side and a portion independent of the head unit. The portion on the head unit side is a rotatably provided member, and is composed of a rotation member including a free end and a spring that presses the rotation member in a direction in which the free end is away from the head unit. The portion independent of the head unit is composed of a driven roller that comes into contact with the rotation member when the head unit is at the recording position. When the head unit moves from the retreat position toward the recording position, the rotation member engages with the driven roller to rotate, and the head unit is pressed by a reaction force received by the rotation member from the driven roller.

As described above, in the configuration described in JP-A-2023-076882, when the head unit moves from the retreat position to the recording position, it receives a pressing force from the unit-pressing unit, which becomes a load when moving to the recording position. Therefore, there may be cases where the head unit cannot be moved appropriately to the recording position.

### SUMMARY

A recording device of the present disclosure for overcoming the above-described problem includes a recording section that records on a medium; a movement mechanism that moves the recording section along a movement direction between a recording position where the recording section records on a medium and a retreat position where the recording section is retreated from the recording position; a positioning section that abuts against a part of the recording section moving in a first direction, and that determines a position of the recording section in the movement direction as a positioning position, assuming that one of a direction from the retreat position toward the recording position and a direction from the recording position toward the retreat position in the movement direction is the first direction and an opposite direction is a second direction; and a pressing unit that, in a state where a part of the recording section is in contact with the positioning section, presses the recording section so as to cancel moment generated in the recording section by force received from the positioning section and the movement mechanism, wherein the pressing unit includes a first advancing and retreating member that is provided independently of the recording section and that is configured to advance and retreat with respect to the recording section, a first pressing member that is provided independently of the recording section and that presses the first advancing and retreating member toward the recording section, a second advancing and retreating member that is provided in the recording section and that is configured to advance and retreat with respect to the first advancing and retreating member, and a second pressing member that is provided in the recording section and that presses the second advancing and retreating member toward the first advancing and retreating member.

### BRIEF DESCRIPTION OF THE DRAWINGS

FIG. 1 is a diagram showing a medium transport path of a printer, and is a diagram showing a state in which a head unit is at a recording position.

FIG. 2 is a diagram showing the medium transport path of the printer, and is a diagram showing a state in which the head unit is at a retreat position.

FIG. 3 is a diagram showing the medium transport path

of the printer, and is a diagram showing a state in which an ink ejection surface is capped by a cap member.

FIG. 4 is a perspective view of the head unit and a movement mechanism, and is a diagram showing a state in which the head unit is at the recording position.

FIG. 5 is a cross-sectional view of the head unit and the movement mechanism, and is a diagram showing a state in which the head unit is at the recording position.

FIG. 6 is a cross-sectional view of the head unit and the movement mechanism, and is a diagram showing a state in which the head unit is at the retreat position.

FIG. 7 is a perspective view of the head unit.

FIG. 8 is a cross-sectional perspective view of a right guide member, and is a diagram showing a state in which the head unit is at the recording position.

FIG. 9 is a cross-sectional perspective view of a left first guide member and a left second guide member, and is a diagram showing a state in which the head unit is at the recording position.

FIG. 10 is a diagram schematically showing a movement region and a position of the head unit.

FIG. 11 is a side view of the head unit and a unit-pressing unit, and is a diagram showing a state in which the head unit is in front of the recording position.

FIG. 12 is a side view of the head unit and the unit-pressing unit, and is a diagram showing a state in which the head unit is at the recording position.

FIG. 13 is a perspective view of a pressing unit.

FIG. 14A is a side view of a part of the head unit and the unit-pressing unit, and is a diagram showing a state in which the head unit is in front of the recording position.

FIG. 14B is a side view of a part of the head unit and the unit-pressing unit, and is a diagram showing a state in which the head unit is at the recording position.

FIG. 14C is a side view of a part of the head unit and the unit-pressing unit, and is a diagram showing a state in which the head unit is at the recording position.

FIG. 15 is a plan view of the head unit and the unit-pressing unit, and is a diagram showing a state in which the head unit is at the recording position.

FIG. 16 is a control block diagram including a schematically shown head unit and various sensors, and is a diagram showing a state in which the head unit is at a home position.

FIG. 17 is a control block diagram including the schematically shown head unit and various sensors, and is a diagram showing a state in which the head unit is in contact with an adjustment cam.

FIG. 18 is a control block diagram including the schematically shown head unit and various sensors, and is a diagram showing a state in which the head unit further moves after being in contact with the adjustment cam.

FIG. 19 is a timing chart showing an example of a detection timing of a first sensor, a second sensor, and the home position, and an operation timing of a motor.

FIG. 20 is a timing chart showing an example of a detection timing of the first sensor, the second sensor, and the home position, and an operation timing of the motor.

FIG. 21 is a flowchart showing a flow of an initial detection operation when the head unit is replaced.

FIG. 22 is a flowchart showing a flow of an operation when moving from the retreat position to the recording position.

FIG. 23 is a flowchart showing a flow of a retry operation.

### DESCRIPTION OF EMBODIMENTS

Hereinafter, the present disclosure will be schematically described.

A recording device according to a first aspect includes a recording section that records on a medium; a movement mechanism that moves the recording section along a movement direction between a recording position where the recording section records on a medium and a retreat position where the recording section is retreated from the recording position; a positioning section that abuts against a part of the recording section moving in a first direction, and that determines a position of the recording section in the movement direction as a positioning position, assuming that one of a direction from the retreat position toward the recording position and a direction from the recording position toward the retreat position in the movement direction is the first direction and an opposite direction is a second direction; and a pressing unit that, in a state where a part of the recording section is in contact with the positioning section, presses the recording section so as to cancel moment generated in the recording section by force received from the positioning section and the movement mechanism, wherein the pressing unit includes a first advancing and retreating member that is provided independently of the recording section and that is configured to advance and retreat with respect to the recording section, a first pressing member that is provided independently of the recording section and that presses the first advancing and retreating member toward the recording section, a second advancing and retreating member that is provided in the recording section and that is configured to advance and retreat with respect to the first advancing and retreating member, and a second pressing member that is provided in the recording section and that presses the second advancing and retreating member toward the first advancing and retreating member.

According to the present aspect, since a pressing unit that presses the recording section so as to cancel a moment generated in the recording section by a force received from the positioning section and the movement mechanism in a state where a part of the recording section is in contact with the positioning section is provided, it is possible to stabilize a posture of the recording section by suppressing the moment.

Furthermore, according to the present aspect, the pressing unit includes a first advancing and retreating member that is provided independently of the recording section and that is configured to advance and retreat with respect to the recording section, and the first pressing member that is provided independently of the recording section and that presses the first advancing and retreating member toward the recording section. Therefore, compared to a configuration of the related art in which the first advancing and retreating member is fixedly provided without advancing and retreating, it is possible to suppress a load when the recording section moves in the first direction, and it is possible for the recording section to appropriately move to the positioning position.

A second aspect is an aspect according to the first aspect, and the recording section includes a main body section including a recording head and a slide member configured to slide relatively with respect to the main body section along the movement direction and the movement mechanism presses the main body section in the first direction by moving the slide member in the first direction in a state where the main body section is in contact with the positioning section.

According to the present aspect, since the movement mechanism presses the main body section in the first direction by moving the slide member in the first direction in a state where the main body section is in contact with the positioning section, it is possible to improve the positioning accuracy of the recording head.

A third aspect is an aspect according to the second aspect, and the recording section includes a first receiving section provided on the slide member, a second receiving section provided on the main body section, and a third pressing member that is provided between the first receiving section and the second receiving section and that presses the second receiving section in the first direction when the slide member moves in the first direction in a state where the main body section is in contact with the positioning section.

According to the present aspect, a position of the recording head is stabilized by the third pressing member, and an appropriate recording quality can be obtained.

A fourth aspect is an aspect according to the second or third aspect, and the recording device further includes a detection section that detects relative displacement between the slide member and the main body section when the recording section moves in the first direction.

In a case where the recording section moves in the first direction and the slide member and the main body section are relatively displaced, the following first case and second case are considered. The first case is a case where the main body section properly abuts against the positioning section. In the second case, before a part of the main body section properly abuts against the positioning section, the movement of the main body section in the first direction is inhibited by a pressing force of the pressing unit, and the main body section stops before abutting the positioning section.

The detection section can detect that the main body section appropriately abuts against the positioning section by detecting the first case. In the second case, since the occurrence can be suppressed by the operation and effect of the first aspect described above, it is possible for the detection section to detect that the main body section appropriately abuts against the positioning section.

A fifth aspect is an aspect according to the second or third aspect, and the movement mechanism moves the recording section in the movement direction by a rack and pinion mechanism and a rack that constitutes the rack and pinion mechanism is provided in the slide member.

According to the present aspect, it is possible to move the recording section with a simple structure by a rack and pinion mechanism.

A sixth aspect is an aspect according to the fourth aspect, and the movement mechanism moves the recording section in the movement direction by a rack and pinion mechanism, a rack that constitutes the rack and pinion mechanism is provided in the slide member, and the detection section detects relative movement between the main body section and the slide member.

According to the present aspect, it is possible to move the recording section with a simple structure by a rack and pinion mechanism.

Further, according to the operation and effect of the fourth aspect described above, it is possible to appropriately detect that the main body section appropriately abuts against the positioning section by the detection section.

A seventh aspect is an aspect according to the first aspect, and the first pressing member and the second pressing member are both springs and a spring constant of the first pressing member is different from a spring constant of the second pressing member.

According to the present aspect, since a spring constant of the first pressing member is different from a spring constant of the second pressing member, when the first advancing and retreating member and the second advancing and retreating member are engaged with each other, the member pressed by the member having a relatively smaller spring constant can easily retreat. As a result, it is possible to appropriately suppress a load when the recording section moves in the first direction, and it is possible for the recording section to more appropriately move to the positioning position.

Furthermore, in a state where a part of the recording section is in contact with the positioning section, a pressing force for pressing the recording section so as to cancel the moment is obtained by compression of the spring having a relatively small spring constant. By this, variations in the pressing force can be suppressed, and an appropriate pressing force can be easily obtained.

Incidentally, when the recording section is moving toward the recording position and the second advancing and retreating member abuts against the first advancing and retreating member, even if a member pressed by a spring with a relatively small spring constant cannot temporarily retreat, a member pressed by a spring with a relatively large spring constant will temporarily retreat, allowing the recording section to appropriately move to the positioning position.

The present aspect is not limited to the first aspect, and may be according to any of the second to the sixth aspects.

An eighth aspect is an aspect according to the first aspect, and the second advancing and retreating member is configured to rotate and advances and retreats with respect to the first advancing and retreating member by rotating, an axis center line of a rotation shaft of the second advancing and retreating member is along a width direction intersecting the movement direction, a free end when the second advancing and retreating member rotates is positioned in the second direction with respect to the rotation shaft, and when the recording section moves in the first direction, the first advancing and retreating member relatively moves from the rotation shaft toward the free end with respect to the second advancing and retreating member.

According to the present aspect, when the recording section moves in the first direction, the first advancing and retreating member relatively moves from the rotation shaft toward the free end with respect to the second advancing and retreating member. By this, as a pressing force applied to the recording section by the pressing unit is gradually increased, it is possible to suppress a sudden load being applied to the recording section.

The present aspect is not limited to the first aspect, and may be according to any of the second to the seventh aspects.

A ninth aspect is an aspect according to the first aspect, and the recording section includes a first guided section at a one-side end section in a width direction intersecting the movement direction, and a second guided section and a third guided section at an other-side end section in the width direction with a gap therebetween in the movement direction, the first guided section is guided in the movement direction by a first guide section extending along the movement direction, the second guided section and the third guided section are guided in the movement direction by a second guide section extending along the movement direction, and the recording section is supported at three positions of the first guided section, the second guided section, and the third guided section in a state where the recording section is at least at the positioning position.

According to the present aspect, since the recording section is configured to be supported at three positions of the first guided section, the second guided section, and the third guided section at the positioning position, the posture of the recording section at the positioning position is stabilized.

The present aspect is not limited to the first aspect, and may be according to any of the second to the eighth aspects.

A tenth aspect is an aspect according to the ninth aspect, and when viewed from a direction orthogonal to a plane including a first position at which the first guided section is in contact with the first guide section, a second position at which the second guided section is in contact with the second guide section, and a third position at which the third guided section is in contact with the second guide section, a position at which the pressing unit applies force to the recording section is within a triangular region connecting the first position, the second position, and the third position.

According to the present aspect, since a position at which the pressing unit applies force to the recording section is within a triangular region connecting the first position, the second position, and the third position, the first guided section is appropriately pressed against the first guide section, the second guided section is appropriately pressed against the second guide section, and the third guided section is appropriately pressed against the second guide section. By this, the posture of the recording section at the positioning position is stabilized.

An eleventh aspect is an aspect according to the tenth aspect, and the second guided section is positioned at a position where the second guided section is about to be lifted up from the second guide section by the moment, the third guided section is positioned at a position where the third guided section is pressed against the second guide section by the moment, and a position at which the pressing unit applies force to the recording section is on a side of the second position with respect to a central position between the first position and the second position in the width direction, and is on a side of the second position with respect to a central position between the second position and the third position in the movement direction.

According to the present aspect, in a configuration where the second guided section is at a position where it is about to rise from the second guide section due to the moment, a position at which the pressing unit applies force to the recording section is on a side of the second position with respect to a central position between the first position and the second position in the width direction, and is on a side of the second position with respect to a central position between the second position and the third position in the movement direction. By this, the recording section is to be pressed at a position close to the second guided section, and the moment is appropriately suppressed.

A twelfth aspect is an aspect according to the first aspect, and the positioning section is a cam section that defines a distance between the recording section and a medium and the positioning position is the recording position.

According to the present aspect, since the positioning section is a cam section that defines a distance between the recording section and a medium and the positioning position is the recording position, the position and the posture of the recording section are stabilized at the recording position, and thus a favorable recording result is obtained.

The present aspect is not limited to the first aspect and may be according to any of the second to the eleventh aspects.

A thirteenth aspect is an aspect according to the first aspect, and the recording device further includes a maintenance section that performs maintenance of the recording section, wherein a movement region of the recording section includes a maintenance position at which maintenance of the recording section is performed, the positioning section is the maintenance section, and the positioning position is the maintenance position.

According to the present aspect, since the positioning section is the maintenance section, and the positioning position is the maintenance position, the position and the posture of the recording section are stabilized at the maintenance position, and a favorable maintenance result is obtained.

The present aspect is not limited to the first aspect and may be according to any of the second to the eleventh aspects.

The present disclosure will be described in detail below.

Hereinafter, an inkjet printer 1 that performs recording by ejecting ink, which is an example of liquid, onto a medium represented by a recording sheet, will be described as an example of a recording device. Hereinafter, the inkjet printer 1 will be referred to simply as a printer 1.

An X-Y-Z coordinate system shown in each drawing is an orthogonal coordinate system, with a Y-axis direction being a direction intersecting a medium transport direction, that is, a medium width direction, and also a device depth direction. In the Y-axis direction, a +Y direction is a direction from a device front surface toward a device rear surface, and a −Y direction is a direction from the device rear surface toward the device front surface. In the present embodiment, the Y-axis direction is an example of a width direction intersecting with a V-axis direction, which is a movement direction of a head unit 50 (to be described later).

An X-axis direction is a device width direction and, as viewed from an operator of the printer 1, a +X direction is to a left side and a −X direction is to a right side. A Z-axis direction is a vertical direction, and is a normal direction with respect to a placement surface G of the printer 1, that is, a device height direction. In the Z-axis direction, a +Z direction is an upward direction and a −Z direction is a downward direction.

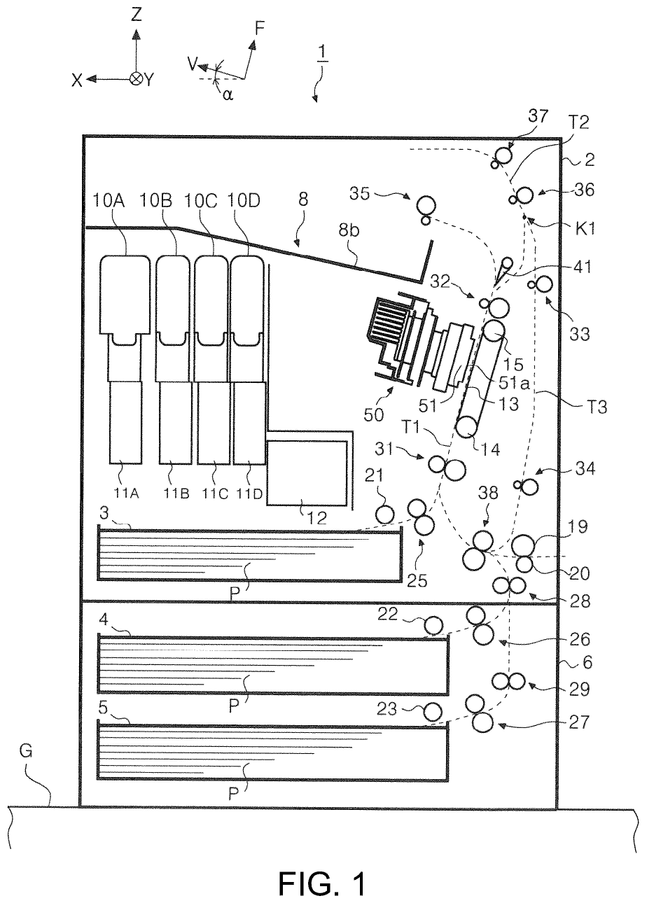

Hereinafter, a direction in which the medium is transported may be referred to as “downstream”, and an opposite direction of it may be referred to as “upstream”. In FIGS. 1, 2, and 3, a medium transport path is indicated by a broken line. In the printer 1, a medium is transported through the medium transport path indicated by a broken line in FIGS. 1, 2, and 3.

An F-axis direction is a direction between a line head 51 and a transport belt 13 (to be described later), that is, a medium transport direction in a recording region, a +F direction is downstream in the transport direction, and a −F direction is upstream in the transport direction. The V-axis direction is orthogonal to the F-axis direction and is a movement direction of the head unit 50 (to be described later), with a +V direction in the V-axis direction being a direction in which the head unit 50 retreats from a recording transport path T1, and a −V direction being a direction in which the head unit 50 moves toward the recording transport path T1.

In some drawings, an F-V-Y coordinate system may be employed instead of the X-Y-Z coordinate system.

Hereinafter, the medium transport path in the printer 1 will be described with reference to FIG. 1. The printer 1 is configured so that an additional unit 6 can be connected to the bottom of the device main body 2, and FIGS. 1, 2, and 3 show the printer 1 with the additional unit 6 connected.

The device main body 2 includes a first medium cassette 3 that accommodates a medium in a lower section, and in a case where the additional unit 6 is connected, a second medium cassette 4 and a third medium cassette 5 are further provided below the first medium cassette 3.

Each of the medium cassettes is provided with a pickup roller that feeds an accommodated medium in the −X direction. The pickup rollers 21, 22, and 23 are pickup rollers provided for the first medium cassette 3, the second medium cassette 4, and the third medium cassette 5, respectively.

Each medium cassette is provided with a feed roller pair that feeds a medium, which was fed in the −X direction, in an obliquely upward direction. The feed roller pairs 25, 26, and 27 are feed roller pairs provided for the first medium cassette 3, the second medium cassette 4, and the third medium cassette 5, respectively.

Note that in the following description, unless otherwise specified, a “roller pair” is configured by a drive roller driven by a motor (not shown) and a driven roller in contact with and driven by the drive roller.

A medium fed from the third medium cassette 5 is fed to a transport roller pair 38 by transport roller pairs 29 and 28. A medium fed from the second medium cassette 4 is fed to the transport roller pair 38 by the transport roller pair 28. The medium is nipped by the transport roller pair 38 and transported to the transport roller pair 31.

The medium fed from the first medium cassette 3 is transported to the transport roller pair 31 by the feed roller pair 25 without passing through the transport roller pair 38.

A feed roller 19 and a separation roller 20 provided in the vicinity of the transport roller pair 38 are a roller pair for feeding a medium from a supply tray (not shown in FIGS. 1, 2, and 3).

A medium that receives a feeding force from the transport roller pair 31 is transported to a position between the line head 51, which is an example of a recording head, and the transport belt 13, that is, a position facing the line head 51. Note that hereafter, a medium transport path from the transport roller pair 31 to a transport roller pair 32 is referred to as a recording transport path T1.

The line head 51 constitutes the head unit 50. The head unit 50 is an example of a recording section that records on a medium. The line head 51 performs recording by ejecting ink, which is an example of liquid, onto a surface of a medium. The line head 51 is an ink ejection head configured such that nozzles for ejecting ink cover an entire region in the medium width direction, and is configured as an ink ejection head that is capable of recording on the entire region in the medium width direction without being moved in the medium width direction. However, the ink ejection head is not limited to this, and may be of a type that is mounted on a carriage and that ejects ink while moving in the medium width direction.

The head unit 50 is provided so as to be able to advance and retreat with respect to the recording transport path T1. The head unit 50 is provided so as to be movable between a recording position at which the head unit 50 advances to the recording transport path T1 and performs recording on a medium and a retreat position at which the head unit 50 is retreated from the recording transport path T1.

In the present embodiment, the V-axis direction is a movement direction of the head unit 50, the −V direction is an example of a first direction from the retreat position toward the recording position, and the +V direction is an example of a second direction from the recording position toward the retreat position. However, the +V direction may be the first direction, and the −V direction may be the second direction.

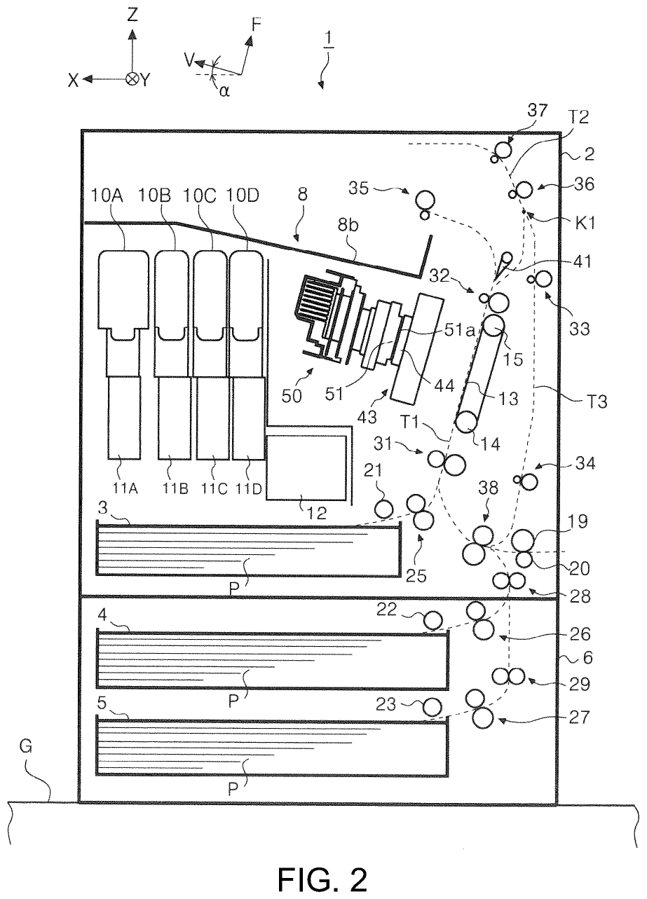

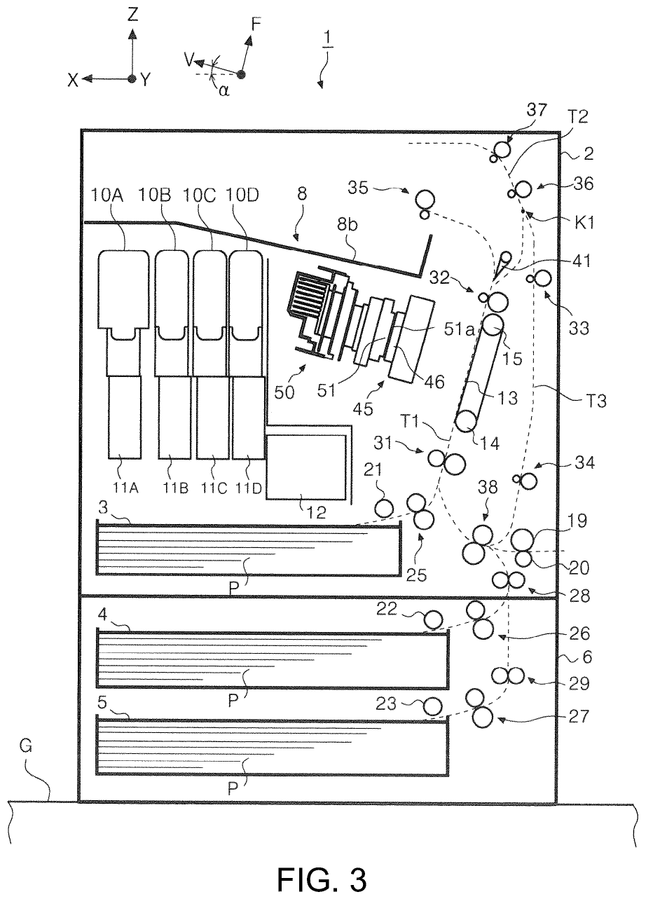

FIG. 1 shows a state in which the head unit 50 is at the recording position, and recording is performed on a medium in this state. FIGS. 2 and 3 show a state in which the head unit 50 is in the retreat position. FIG. 2 shows a position of the head unit 50 when wiping an ink ejection surface 51a of the line head 51. FIG. 3 shows a position of the head unit 50 when the ink ejection surface 51a is capped by a cap member 46.

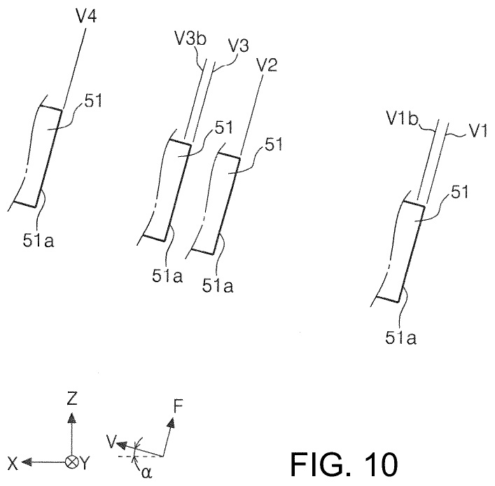

Here, a movement range of the head unit 50 will be described with reference to FIG. 10. FIG. 10 schematically shows a movement range of the head unit 50. In FIG. 10, a position of the head unit 50 in the V-axis direction is based on a V-axis direction position of the ink ejection surface 51a.

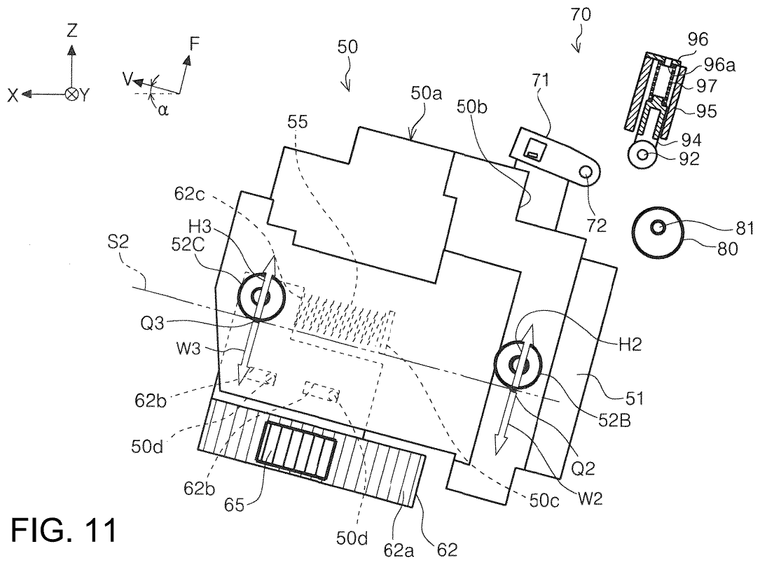

In FIG. 10, a position V1 is a position where the head unit 50 most advances into the recording transport path T1, is an example of the recording position, and corresponds to a position of the head unit 50 shown in FIG. 1. The recording position can be adjusted by an adjustment cam 80 (refer to FIG. 11) which will be described later, and a position V1b is the most +V direction position in an adjustment range of the recording position. In FIG. 10, the line head 51 at the position V1b is omitted. When the head unit 50 is at the position V1, at the position V1b, or between the position V1 and the position V1b, recording is performed on a medium.

The position V4 is a position at which the head unit 50 is farthest from the recording transport path T1 in the +V direction, and is an example of the retreat position. When the head unit 50 is at the position V4, it is possible to attach and detach the head unit 50. How to attach and detach the head unit 50 will be described later.

The position V2 is a position at which the ink ejection surface 51a of the line head 51 is wiped, and is an example of the retreat position. FIG. 2 shows a state in which the head unit 50 is at the position V2. In FIG. 2, reference symbol 43 denotes a wiper unit, and reference symbol 44 denotes a wiper provided in the wiper unit 43. The wiper 44 is formed of an elastic material such as rubber or elastomer, and can be pressed against the ink ejection surface 51a by elasticity.

The wiper unit 43 is provided so as to be movable in the Y-axis direction, which is a direction along the ink ejection surface 51a by a motor (not shown), and a end section position in the +Y direction in a movable region is set as a home position, and the wiper unit 43 is positioned at the home position except when wiping. When the wiper unit 43 moves in the Y-axis direction, the ink ejection surface 51a is wiped by the wiper 44.

A position V3 in FIG. 10 is a position at which the ink ejection surface 51a is capped by the cap member 46 (refer to FIG. 3), and is an example of a retreat position. A position V3b is a position at which a flushing operation is performed with respect to the cap member 46, that is, ink is discharged from all ink ejection nozzles (not shown) of the line head 51, and is an example of the retreat position. In FIG. 10, the line head 51 at the position V3b is omitted.

In FIG. 3, the cap member 46 is provided on the cap unit 45. The cap unit 45 is provided so as to be movable along the F-axis direction and moves in the F-axis direction by receiving power from a power source (not shown). The cap unit 45 moves along the F-axis direction to a capable position where the cap member 46 can face the ink ejection surface 51a of the line head 51, as shown in FIG. 3, and a separated position where the cap member 46 does not face the ink ejection surface 51a of the line head 51. The cap member 46 is made of an elastic material and is made of a rubber material, for example.

Referring back to FIGS. 1 to 3, reference symbols 10A, 10B, 10C, and 10D denote ink containers serving as liquid containers. Ink being ejected from the line head 51 is supplied to the line head 51 from each ink container via tubes (not shown).

The ink containers 10A, 10B, 10C, and 10D are provided to be attachable to and detachable from mount sections 11A, 11B, 11C, and 11D, respectively.

Reference symbol 12 denotes a waste liquid container that stores ink as waste liquid that is ejected from the line head 51 toward the cap member 46 for maintenance.

The transport belt 13 is an endless belt that is wound around a pulley 14 and a pulley 15, and rotates by at least one of the pulley 14 and the pulley 15 being driven by a motor (not shown). A medium is transported to a position facing the line head 51 while being attracted to a belt surface of the transport belt 13. A known attraction methods such as an air suction method or an electrostatic adsorption method can be used to attract a medium onto the transport belt 13.

Here, the recording transport path T1 passing through a position facing the line head 51 is configured to intersect both the horizontal direction and the vertical direction and transport the medium upward. By this, the V-axis direction, which is the movement direction of the head unit 50, also intersects both the horizontal direction and the vertical direction, and an inclination angle α of the V-axis direction with respect to the horizontal direction is smaller than 45°, more specifically, approximately 15°.

With such a configuration, it is possible to balance the size of the space required for movement of the head unit 50 in the horizontal direction and the vertical direction, and it is possible to prevent the device from becoming extremely large in the horizontal direction and the vertical direction.

Incidentally, not limited to the above-described configuration, the V-axis direction may be parallel to the horizontal direction.

A discharge tray 8, which forms a support surface 8b that supports a medium discharged from the medium transport path, is provided on a upper section of the head unit 50. The support surface 8b extends along the V-axis direction, which is the movement direction of the head unit 50. By this, a useless space is not formed in the relationship between the discharge tray 8 and a movement region of the head unit 50, and thus it is possible to suppress an increase in size of the device.

Since a part of the head unit 50 overlaps with the ink containers 10A to 10D in the Z-axis direction, the device dimension in the Z-axis direction can be suppressed.

Next, a medium on which recording is performed on a first surface by the line head 51 is further transported in an upward direction by the transport roller pair 32 positioned downstream of the transport belt 13.

A flap 41 is provided downstream of the transport roller pair 32, and the flap 41 switches a transport direction of a medium. In a case when a medium is to be discharged as is, the flap 41 switches a transport path of a medium so that the medium directs toward an upper transport roller pair 35, and the medium is discharged toward the discharge tray 8 by the transport roller pair 35.

When recording is to be performed on a second surface in addition to a first surface of a medium, a transport direction of a medium is directed to a branch position K1 by the flap 41. Then, the medium passes through the branch position K1 and enters a switchback path T2. In the present embodiment, the switchback path T2 is a medium transport path on an upper side from the branch position K1. Transport roller pairs 36 and 37 are provided in the switchback path T2. The medium that has entered the switchback path T2 is transported upward by the transport roller pairs 36 and 37, and when a lower edge of the medium has passed through the branch position K1, rotational directions of the transport roller pairs 36 and 37 are switched, whereby the medium is transported downward.

An inversion path T3 is connected to the switchback path T2. In the present embodiment, the inversion path T3 is a medium transport path that extends from the branch position K1 through the transport roller pairs 33 and 34 to the transport roller pair 38.

The medium transported downward from the branch position K1 receives feeding forces from transport roller pairs 33 and 34, reaches the transport roller pair 38, is curved and inverted, and is transported to the transport roller pair 31.

In the medium that is transported to a position that faces the line head 51 again, the second surface that is opposite to the first surface on which recording is already performed faces the line head 51. By this, it is possible to perform recording on the second surface of the medium by the line head 51.

Next, the movement mechanism 60 that moves the head unit 50 along the V-axis direction will be described.

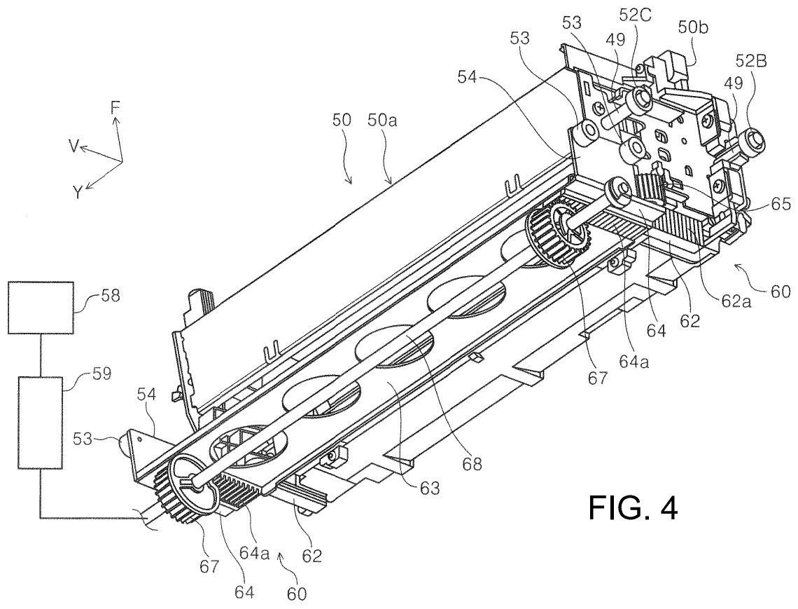

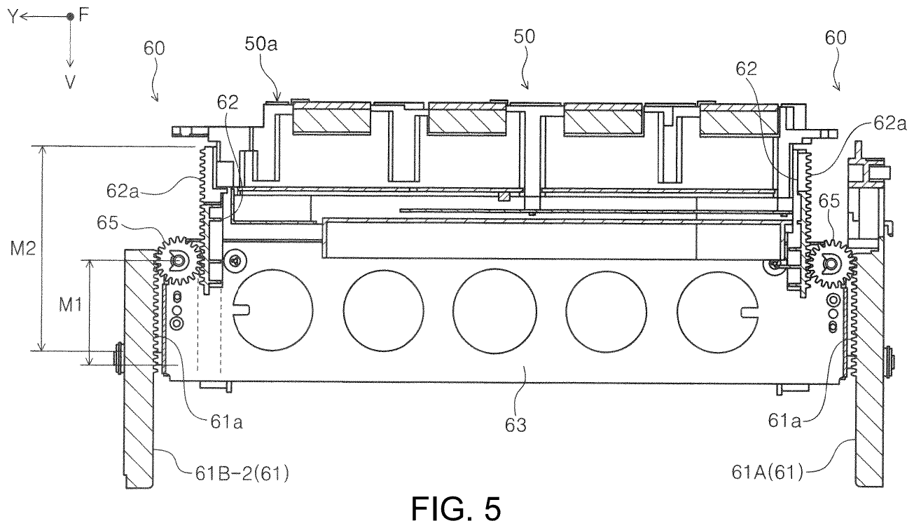

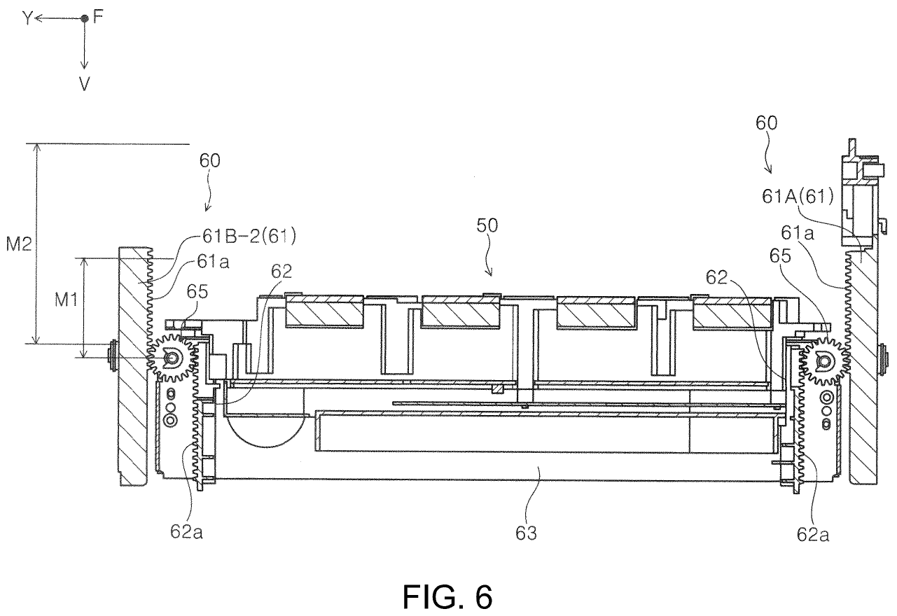

The movement mechanism 60 includes a right guide member 61A, a left second guide member 61B-2, a second member 63, and first pinions 65, which are shown in FIGS. 5 and 6, and third rack forming members 64 and second pinions 67, which are shown in FIG. 4, and is configured so that the first pinion 65 applies an external force in the movement direction to the second rack forming member 62 that constitutes the head unit 50, that is, a rack and pinion mechanism.

The second rack forming member 62 is an example of a slide member, and constitutes the head unit 50 together with a main body section 50a. The head unit 50 is composed of the main body section 50a, which includes the line head 51, and the second rack forming members 62.

The second rack forming member 62 and the main body section 50a are relatively displaceable along the V-axis direction, which will be described later.

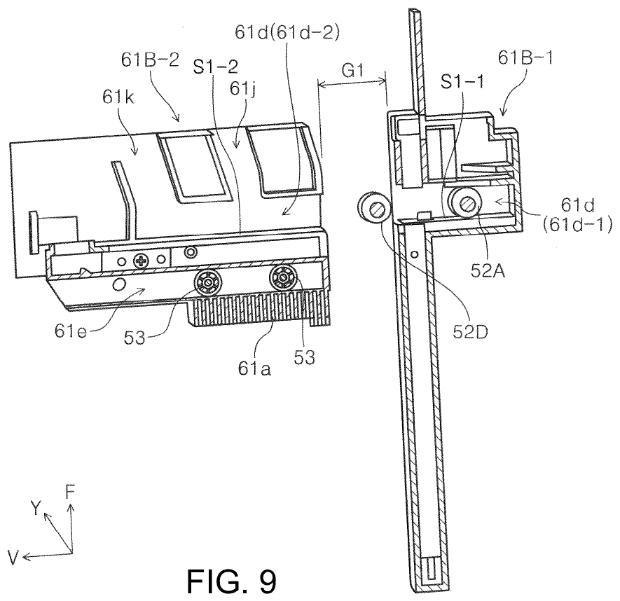

A left first guide member 61B-1 shown in FIG. 9 is provided in the −V direction with respect to the left second guide member 61B-2. In the following, the right guide member 61A, the left first guide member 61B-1, and the left second guide member 61B-2 may be collectively referred to as “guide member 61” when it is not necessary to distinguish between them.

The guide member 61 is fixedly provided to a frame (not shown) of the device.

First, a configuration for guiding the head unit 50 in the V-axis direction will be described below.

As shown in FIG. 4, a second guided roller 52B and a third guided roller 52C are provided on a side section in the −Y direction of the Y-axis direction of the head unit 50, that is, on a side section facing the right guide member 61A. The second guided roller 52B and the third guided roller 52C are each provided on a shaft 49 protruding in the −Y direction. The second guided roller 52B and the third guided roller 52C are bearings provided so as to be freely rotatable with respect to shaft 49. The second guided roller 52B and the third guided roller 52C are provided with a gap along the V-axis direction, and the second guided roller 52B is positioned in the −V direction with respect to the third guided roller 52C.

The second guided roller 52B is an example of a second guided section, and the third guided roller 52C is an example of a third guided section.

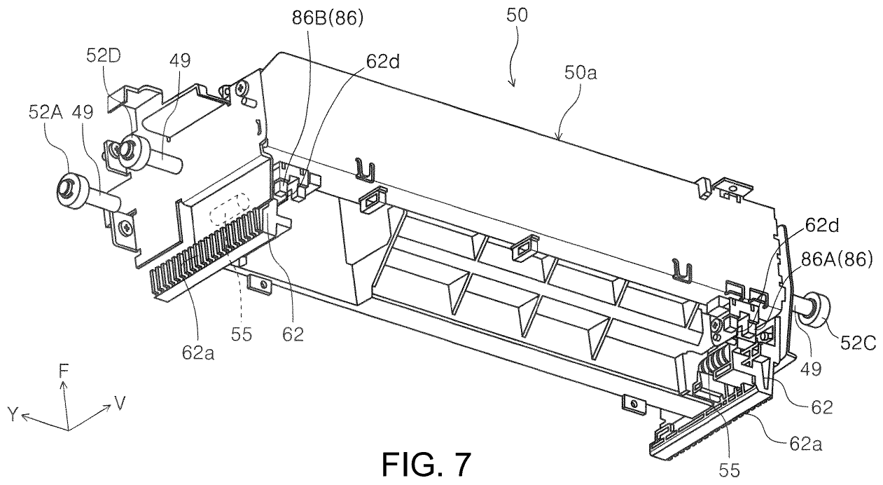

As shown in FIG. 7, a first guided roller 52A and a fourth guided roller 52D are provided on a side section in the +Y direction of the Y-axis direction of the head unit 50, that is, on a side section facing the left first guide member 61B-1 and the left second guide member 61B-2. In FIG. 7, the movement mechanism 60 shown in FIG. 4 is omitted, and only the head unit 50 is shown.

The first guided roller 52A and the fourth guided roller 52D are each provided on the shaft 49 protruding in the +Y direction. The first guided roller 52A and the fourth guided roller 52D are bearings provided so as to be freely rotatable with respect to shaft 49. The first guided roller 52A and the fourth guided roller 52D are provided with a gap along the V-axis direction, and the first guided roller 52A is positioned in the −V direction with respect to the fourth guided roller 52D.

The first guided roller 52A is an example of a first guided section.

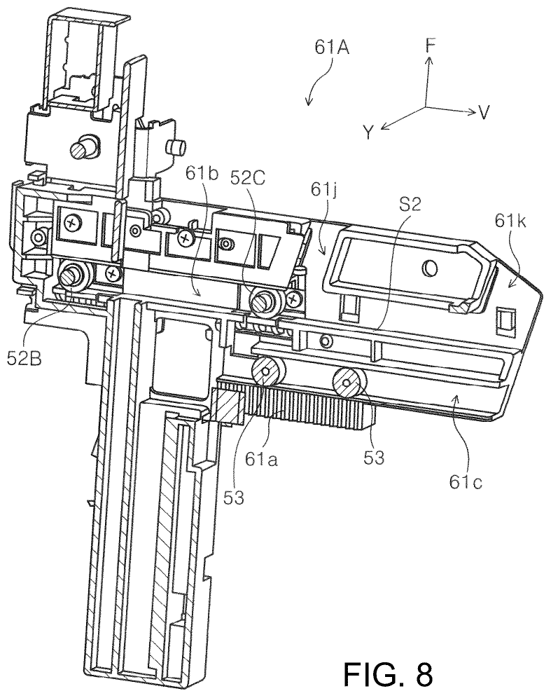

As shown in FIG. 8, a right first guide groove 61b is formed along the V-axis direction in the right guide member 61A arranged to face a side section of the head unit 50 in the −Y direction. The second guided roller 52B and the third guided roller 52C provided on a side section of the head unit 50 in the −Y direction enter the right first guide groove 61b, and thus a side section of the head unit 50 in the −Y direction is guided in the V-axis direction by the right first guide groove 61b.

Reference symbol S2 denotes a lower surface of the right first guide groove 61b, and this surface is hereinafter referred to as a second guide surface. The second guided roller 52B and the third guided roller 52C are supported by the second guide surface S2 and receive reaction forces from the second guide surface S2.

A normal force that the second guided roller 52B receives from the second guide surface S2 is indicated by an arrow with reference symbol H2 in FIG. 11. A normal force that the third guided roller 52C receives from the second guide surface S2 is indicated by an arrow with reference symbol H3 in FIG. 11. In addition, in FIG. 11, an arrow denoted by reference symbol W2 indicates a force with which the second guided roller 52B contacts the second guide surface S2 perpendicularly due to the weight of the head unit 50, and an arrow denoted by reference symbol W3 indicates a force with which the third guided roller 52C contacts the second guide surface S2 perpendicularly due to the weight of the head unit 50.

As an inclination angle α between the V-axis direction and the horizontal direction increases, the normal forces H2 and H3 and the forces W2, W3 all become smaller.

Next, as shown in FIG. 9, a left first guide groove 61d is formed along the V-axis direction in the left first guide member 61B-1 and the left second guide member 61B-2, which are arranged to face a +Y direction side section of the head unit 50. The left first guide member 61B-1 is positioned in the −V direction with respect to the left second guide member 61B-2, and there is a gap G1 provided between the left first guide member 61B-1 and the left second guide member 61B-2 in the V-axis direction. Therefore, the left first guide groove 61d is in a state of being divided within a range of the gap G1. In FIG. 9, a left first guide groove formed in the left first guide member 61B-1 is denoted by reference symbol 61d-1, and a left first guide groove formed in the left second guide member 61B-2 is denoted by reference symbol 61d-2. However, in the following, these may be collectively referred to as the left first guide groove 61d.

The gap G1 is a gap for the wiper unit 43 described with reference to FIG. 2 to move in the Y-axis direction through between the left first guide member 61B-1 and the left second guide member 61B-2.

The first guided roller 52A and the fourth guided roller 52D provided on a side section of the head unit 50 in the +Y direction enter the left first guide groove 61d, whereby a side section of the head unit 50 in the +Y direction is guided in the V-axis direction by the left first guide groove 61d.

Reference symbol S1-1 is a lower surface of the left first guide groove 61d-1. Reference symbol S1-2 is a lower surface of the left first guide groove 61d-2. Each of the surfaces S1-1 and S1-2 is hereinafter referred to as a first guide surface. The first guide surfaces S1-1 and S1-2 are parallel to the second guide surface S2.

The first guided roller 52A and the fourth guided roller 52D are supported by the first guide surface S1-1 or the first guide surface S1-2, and a receive reaction force from the first guide surface S1-1 or the first guide surface S1-2.

Here, FIG. 9 shows a state in which the head unit 50 is at the recording position, and in this state, as shown in the figure, the first guided roller 52A is inside the left first guide groove 61d-1 and supported by the first guide surface S1-1, but the fourth guided roller 52D is inside the gap G1 and is not supported by any of the first guide surfaces S1-1 and S1-2.

Therefore, when the head unit 50 is at the recording position, the head unit 50 is supported at one point by the first guided roller 52A on a side section in the +Y direction, and at two points by the second guided roller 52B and the third guided roller 52C on a side section in the −Y direction, resulting in a total support at three points.

As is clear from FIG. 9, when the head unit 50 moves from the recording position toward the retreat position, the first guided roller 52A and the fourth guided roller 52D enter the left first guide groove 61d-2 and are supported by the first guide surface S1-2.

Since the gap G1 is smaller than a gap between the first guided roller 52A and the fourth guided roller 52D in the V-axis direction, at least one of the first guided roller 52A and the fourth guided roller 52D is supported by either the first guide surface S1-1 or the first guide surface S1-2 at a side section of the head unit 50 in the +Y direction.

A third guide groove 61j and a fourth guide groove 61k are formed in the left second guide member 61B-2 along a direction intersecting the left first guide groove 61d. When the head unit 50 moves to the retreat position in the most +V direction, the first guided roller 52A faces the third guide groove 61j, and the fourth guided roller 52D faces the fourth guide groove 61k. In this state, the first guided roller 52A can move upward along the third guide groove 61j, and the fourth guided roller 52D can move upward along the fourth guide groove 61k.

Similarly, in the right guide member 61A described with reference to FIG. 8, the third guide groove 61j and the fourth guide groove 61k are formed along a direction intersecting the right first guide groove 61b. When the head unit 50 moves to the retreat position in the most +V direction, the second guided roller 52B faces the third guide groove 61j, and the third guided roller 52C faces the fourth guide groove 61k. In this state, the second guided roller 52B can move upward along the third guide groove 61j, and the third guided roller 52C can move upward along the fourth guide groove 61k.

Although the third guide groove 61j and the fourth guide groove 61k form a slight angle with respect to the F-axis direction, they are generally formed along the F-axis direction.

Thus, when the head unit 50 moves to the retreat position in the most +V direction, the head unit 50 can be removed upward. The head unit 50 can be attached to the device main body 2 by a procedure reverse to a removal procedure. The third guide groove 61j and the fourth guide groove 61k function as a guide section that guides the head unit 50 in an attachment and detachment direction.

Since the head unit 50 is detachable from the device main body 2 in this manner, maintenance or replacement of the head unit 50 is facilitated.

Subsequently, as shown in FIGS. 5 and 6, a first rack 61a is formed in the guide member 61 along the V-axis direction on a side facing the head unit 50.

Second rack forming members 62 are provided at both end sections of the head unit 50 in the Y-axis direction, and second racks 62a are formed in the second rack forming members 62 along the V-axis direction. The first rack 61a and the second rack 62a face each other, with the first pinion 65 arranged between them, and the first pinion 65 meshes with both the first rack 61a and the second rack 62a.

The teeth of the first rack 61a, the second rack 62a, and the first pinion 65 are all aligned along the F-axis direction, with a tooth width direction being perpendicular to the movement direction of the head unit 50.

The first pinion 65 is rotatably provided in the second member 63. As shown in FIG. 4, lower roller support members 54 are provided on both side sections of the second member 63 in the Y-axis direction, and two lower rollers 53 are provided on the lower roller support members 54 at a gap along the V-axis direction. The lower roller 53 is a driven roller supported by the lower roller support member 54 so as to be freely rotatable.

Two lower rollers 53 provided on a side section in the −Y direction of the head unit 50 enter a right second guide groove 61c formed along the V-axis direction in the right guide member 61A as shown in FIG. 8, and are guided in the V-axis direction by the right second guide groove 61c.

Two lower rollers 53 provided on a side section of the head unit 50 in the +Y direction enter a left second guide groove 61e formed along the V-axis direction in the left second guide member 61B-2 as shown in FIG. 9, and are guided in the V-axis direction by the left second guide groove 61e.

As shown in FIG. 4, on a lower side of the second member 63, the third rack forming member 64 is provided, and on a lower side of the third rack forming member 64, a third rack 64a is formed along the V-axis direction. A tooth width direction of the third rack 64a is along the Y-axis direction. The second pinion 67 meshes with the third rack 64a.

The third rack forming members 64 are provided at both end sections in the Y-axis direction on a lower side of the second member 63. The second pinion 67 is provided at a position facing the third rack 64a on a rotation shaft 68, which has a rotation axis center parallel to the Y-axis direction, and the two second pinions 67 are configured to rotate simultaneously with the rotation of the rotation shaft 68. The power of a motor 59 is transmitted to the rotation shaft 68 via a gear mechanism (not shown) in FIG. 4.

In FIG. 4, reference symbol 58 denotes a control section for controlling the motor 59. The control section 58 can grasp a V-axis direction position of the head unit 50 based on a signal received from a reference position sensor (not shown) and the drive amount of the motor 59.

In the above-described configuration, when the second pinions 67 are rotated by the power of the motor 59, the second member 63 is moved along the V-axis direction. Here, since the guide member 61 shown in FIGS. 5 and 6, that is, the first rack 61a is fixedly provided, the first pinion 65 provided on the second member 63 moving in the V-axis direction rotates based on meshing with the first rack 61a.

Since the first pinion 65 meshes with the second rack 62a provided in the head unit 50, the head unit 50 moves so as to be pushed out in the V-axis direction by the rotation of the first pinion 65.

For example, with the head unit 50 at the recording position shown in FIG. 5, when the second member 63 is moved in the +V direction by the power of the motor 59, the first pinion 65 on a right side of FIG. 5 rotates in a counterclockwise direction in FIG. 5, and the first pinion 65 on a left side of FIG. 5 rotates in a clockwise direction in FIG. 5. This causes the head unit 50 to move in the +V direction.

When the head unit 50 is at the retreat position shown in FIG. 6, and the second member 63 is moved in the −V direction by the power of the motor 59, the first pinion 65 on a right side in FIG. 6 rotates in a clockwise direction, and the first pinion 65 on a left side in FIG. 6 rotates in a counterclockwise direction. This causes the head unit 50 to move in the −V direction.

Strictly speaking, the head unit 50 is subjected to a force that tends to move it in the −V direction due to the operation of gravity. This is because the −V direction includes a −Z direction component. Therefore, in a case where the head unit 50 moves in the −V direction, the movement mechanism 60 applies a force in the +V direction to the head unit 50, and is in a state of restricting the movement of the head unit 50 in the −V direction due to the operation of gravity. However, after the head unit 50 comes into contact with an adjustment cam 80 (refer to FIG. 11), which will be described later, the movement mechanism 60 applies a force in the −V direction to the head unit 50, which will be described later.

When the head unit 50 moves in the +V direction, the movement mechanism 60 applies a force in the +V direction to the head unit 50.

Here, a range in the V-axis direction indicated by reference symbol M1 in FIGS. 5 and 6 is a movement range of the second member 63 with the rotation axis center of the first pinion 65 as the reference. A range in the V-axis direction indicated by reference symbol M2 in FIGS. 5 and 6 is a movement range of the head unit 50 based on a −V direction end section position of the second rack forming member 62.

As described above, the head unit 50 is moved in the V-axis direction by the rotation of the first pinion 65, but since the first pinion 65 itself is also moved in the V-axis direction, the movement range M2 of the head unit 50 is larger than the movement range M1 of the second member 63. In the present embodiment, the movement range M2 is approximately twice as large as the movement range M1.

As described above, the movement mechanism 60 includes the guide member 61 in which the first rack 61a is formed along the movement direction of the head unit 50, the first pinion 65 that meshes with the first rack 61a, the second rack 62a that is a rack provided at a position facing the first rack 61a in the head unit 50 and formed along the V-axis direction that is the movement direction of the head unit 50 and meshes with the first pinion 65, and the second member 63 in which the first pinion 65 is rotatably provided and that can move in the V-axis direction by receiving the power of the motor 59. Then, by the rotation of the first pinion 65 moving in the V-axis direction, the movement amount of the head unit 50 increases more than the movement amount of the second member 63. In other words, since the movement amount of the head unit 50 can be secured while suppressing the movement amount of the second member 63, enlargement of a mechanism for moving the second member 63 can be suppressed, and specifically, in the present embodiment, the length of the third rack 64a in the V-axis direction can be suppressed. As a result, it is possible to suppress an increase in the size of the printer 1.

Since the movement mechanism 60 are provided on both sides of the head unit 50 in the Y-axis direction, it is possible to equalize the movement amount in the V-axis direction on one end side and the other end side of the head unit 50 in the Y-axis direction. By this, it is possible to move the head unit 50 in the V-axis direction while appropriately maintaining the posture of the head unit 50.

Further, the tooth width direction of the first rack 61a, the second rack 62a, and the first pinion 65 is along the F-axis direction, and the F-axis direction is substantially along the attachment and detachment direction of the head unit 50. By this, when the head unit 50 is attached and detached, the meshing of the first rack 61a, the second rack 62a, and the first pinion 65 does not interfere with the attachment and detachment of the head unit 50, and the head unit 50 can be easily attached and detached.

In addition, even if the first pinion 65 vibrates in the tooth width direction during the movement of the second member 63, the vibration is hardly transmitted to the second rack 62a, that is, the head unit 50, so that the head unit 50 can be protected from the vibration, and the failure of the head unit 50 can be suppressed.

The tooth width directions of the first rack 61a, the second rack 62a, and the first pinion 65 are along the F-axis direction and form a slight angle with respect to the attachment and detachment direction of the head unit 50 in the present embodiment, but may be parallel to the attachment and detachment direction of the head unit 50.

As shown in FIG. 4, since a plurality of third racks 64a and a plurality of second pinions 67 are provided in the Y-axis direction, it is possible to move the second member 63 in the V-axis direction while appropriately maintaining the posture of the second member 63. By this, the head unit 50 can be moved while the posture of the head unit 50 is appropriately maintained.

Next, the configuration of the head unit 50 will be further described.

As described above, the head unit 50 includes the main body section 50a including the line head 51, and the second rack forming member 62 that is an example of a slide member.

The main body section 50a is provided with engagement pins 50d (refer to FIG. 11) on both side sections in the Y-axis direction as portions to be engaged with the second rack forming members 62. Two engagement pins 50d are provided on both side sections of the main body section 50a in the Y-axis direction at a gap in the V-axis direction. The second rack forming member 62 is provided with two guide holes 62b extending in the V-axis direction at a gap along the V-axis direction, and the engagement pins 50d enter the guide holes 62b, so that the main body section 50a and the second rack forming members 62 can be relatively displaced along the V-axis direction while being connected to each other.

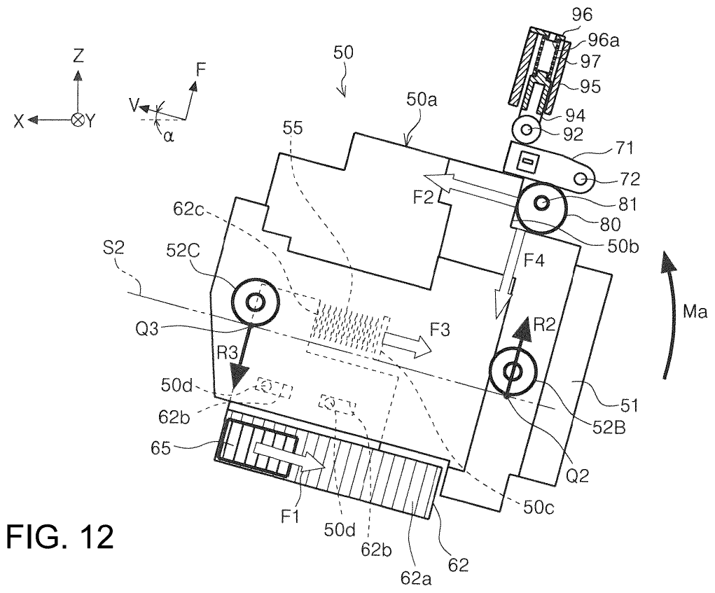

A spring 55, which is an example of a third pressing member, is provided between the main body section 50a and the second rack forming member 62 (refer to also FIG. 7). The spring 55 is a compression coil spring in the present embodiment. However, the spring 55, as long as it can exert a force F3 (refer to FIG. 12) to be described later between the main body section 50a and the second rack forming member 62, is not limited to a compression coil spring, and may be a tension coil spring, torsion coil spring, or the like.

In FIG. 11, reference symbol 50c denotes a second receiving section included in the main body section 50a, and reference symbol 62c denotes a first receiving section included in the second rack forming member 62. The spring 55 exerts a pressing force between the second receiving section 50c and the first receiving section 62c, and the pressing force acts so as to separate the second receiving section 50c and the first receiving section 62c.

In a state where the head unit 50 is not in contact with an adjustment cam 80 (to be described later), the spring 55 is in its most expanded state between the second receiving section 50c and the first receiving section 62c, and the engagement pin 50d is positioned in the −V direction in the guide hole 62b.

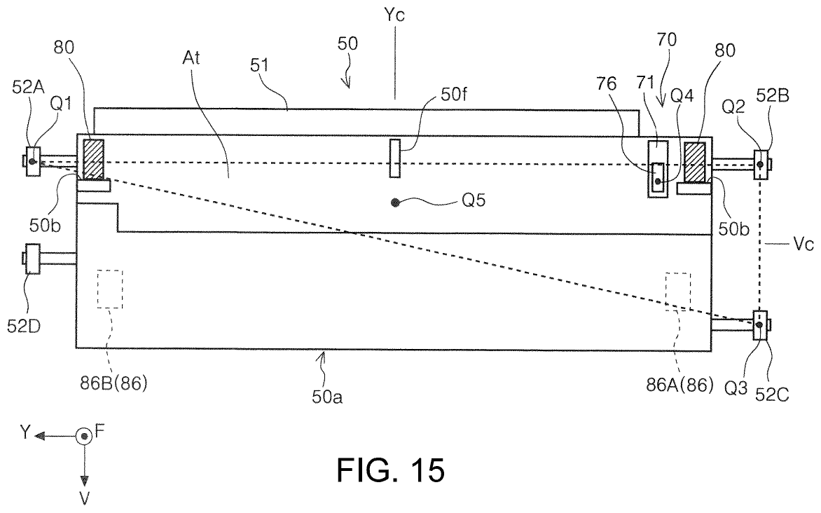

Next, the adjustment cam 80 is provided in the −V direction with respect to the head unit 50. The adjustment cam 80 is provided so as to be rotatable about an eccentric shaft 81 by receiving power from a motor (not shown). The adjustment cams 80 are provided on both side sections of the head unit 50 in the Y-axis direction as shown in FIG. 15. In FIG. 15, the adjustment cams 80 are hatched for convenience of illustration.

The head unit 50 is provided with cam contact surfaces 50b that abut the adjustment cams 80. Cam contact surfaces 50b are also provided on both side sections of the head unit 50 in the Y-axis direction as shown in FIG. 15.

The recording position of the head unit 50 is defined by the contact of the cam contact surface 50b with the adjustment cam 80. That is, the adjustment cam 80 comes into contact with a part of the head unit 50 from the retreat position toward the recording position, and functions as a positioning section that defines the position of the head unit 50 at the recording position. The recording position is an example of a positioning position by the adjustment cam 80.

Here, since the adjustment cam 80 rotates about the eccentric shaft 81, it is possible to adjust the position of the cam contact surface 50b in the V-axis direction by rotating the adjustment cam 80, that is, it is possible to adjust the recording position. The adjustment of the recording position is performed according to, for example, the thickness of a medium on which recording is performed.

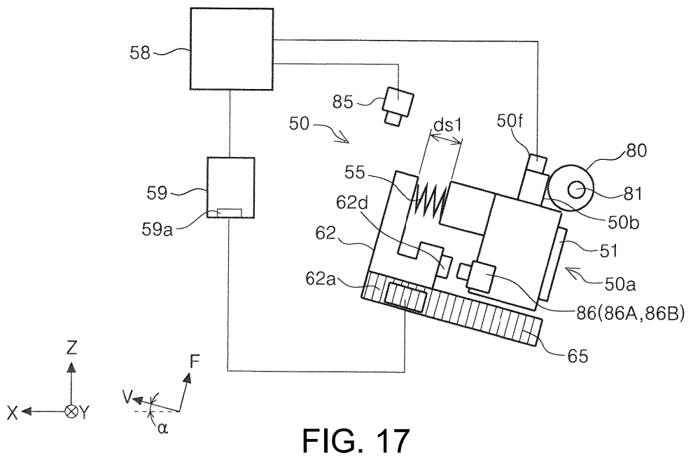

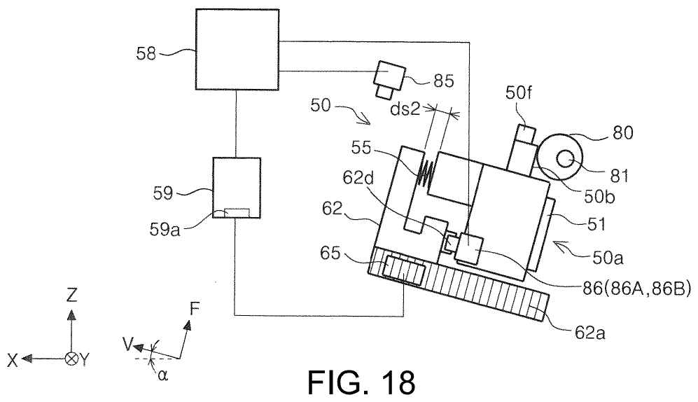

When the control section 58 (refer to FIG. 4) drives the motor 59 to move the head unit 50 to the recording position, the control section 58 further drives the motor 59 from the state in which the cam contact surface 50b abuts against the adjustment cam 80 to move the second rack forming member 62 in the −V direction. At this time, since the cam contact surface 50b of the main body section 50a is in contact with the adjustment cam 80 and does not move in the −V direction, only the second rack forming member 62 moves in the −V direction as shown by the change from FIG. 17 to FIG. 18. The spring 55 is contracted by the relative movement of the main body section 50a and the second rack forming member 62, and a force F3 shown in FIG. 12 is applied to the main body section 50a.

As described above, the head unit 50 includes the main body section 50a including the line head 51, the second rack forming member 62 that is relatively displaceable along the movement direction of the head unit 50 with respect to the main body section 50a, and the spring 55 interposed between the main body section 50a and the second rack forming member 62, pressing the main body section 50a toward the adjustment cam 80 when the head unit 50 is at the recording position. The movement mechanism 60 is configured to apply a force for moving the head unit 50 with respect to the second rack forming member 62. By this, high accuracy is not required for the stopping accuracy when the head unit 50 is moved toward the recording position by the movement mechanism 60 and stopped in a state where the main body section 50a is in contact with the adjustment cam 80, making the position control of the head unit 50 easier.

In a state shown in FIG. 12, the first pinion 65 applies a force F1 in the −V direction to the second rack forming member 62. In order to maintain this state, the control section 58 (refer to FIG. 4) may perform hold control of the motor 59. By applying the force F1 in this manner, the spring 55 is contracted, and the force F3 in the −V direction can be applied to the main body section 50a.

In this state, the main body section 50a receives a +V direction reaction force F2 from the adjustment cam 80 at a position of the cam contact surface 50b.

Since a direction of the force F1 and a direction of the reaction force F2 are opposite to each other and acting positions are separate from each other, a moment Ma, which tends to rotate in a counterclockwise direction in FIG. 12, is generated in the head unit 50.

Note that both force F1 and reaction force F2 act on a side section in the +Y direction and a side section in the −Y direction, and in the present embodiment, the magnitude of the force F1 acting on the side section in the +Y direction and the magnitude of the force F1 acting on the side section in the −Y direction are substantially the same, and the magnitude of the reaction force F2 acting on the side section in the +Y direction and the magnitude of the reaction force F2 acting on the side section in the −Y direction are substantially the same. Therefore, the moment Ma is also generated with substantially the same magnitude at a side section in the +Y direction and a side section in the −Y direction.

The moment Ma acts on the third guided roller 52C as a pressing force R3 to be pressed against the second guide surface S2, and acts on the second guided roller 52B as a lifting force R2 to be lifted from the second guide surface S2.

Since the pressing force R3 enhances a force W3 by which the third guided roller 52C contacts the second guide surface S2 due to the weight of the head unit 50, the third guided roller 52C does not lift off from the second guide surface S2. On the other hand, since the lifting force R2 acts so as to cancel a force W2 by which the second guided roller 52B comes into contact with the second guide surface S2 due to the weight of the head unit 50, when the lifting force R2 overcomes the force W2, the second guided roller 52B lifts off from the second guide surface S2. By this, the posture of the head unit 50 becomes inappropriate, which may adversely affect the recording quality.

Since the head unit 50 is supported at one position of the first guided roller 52A on a +Y direction side, there is no lifting of the first guided roller 52A from the first guide surface S1-1, but as the head unit 50 is in a state where it can easily rotate with the first guided roller 52A as a fulcrum, the posture becomes unstable due to the influence of the moment Ma.

The moment Ma increases as the force F1 increases. The moment Ma increases as the force F3 increases. The force F1 and the force F3 are in a proportional relationship, and as the force F1 increases, the force F3 increases. Since the reaction force F2 depends on the weight of the main body section 50a and the force F3 (force F1), the reaction force F2 increases as the force F3 (force F1) increases. As the reaction force F2 increases, the moment Ma increases accordingly. The moment Ma increases as an acting position of the force F1 and an acting position of the reaction force F2 are separated from each other in the F-axis direction.

In the present embodiment, the second rack forming member 62 and the main body section 50a are engaged by the two guide holes 62b and the two engagement pins 50d (refer to FIG. 12), and are configured such that they cannot rotate relative to each other in an X-Z plane. However, for example, when there is play between the guide hole 62b and the engagement pin 50d, and the second rack forming member 62 and the main body section 50a can relatively rotate to some extent in the X-Z plane, the moment

Ma is generated in the main body section 50a by the force F3 and the reaction force F2. By this, the posture of the main body section 50a becomes inappropriate, which may adversely affect the recording quality.

In the present embodiment, in order to suppress the posture of the head unit 50, particularly, the posture of the main body section 50a from becoming unstable due to the moment Ma, a pressing unit 70 is provided that applies a pressing force F4 to the head unit 50, particularly, the main body section 50a in a direction that cancels the rotation caused by the moment Ma.

The pressing unit 70 will be described later.

Next, a control when the head unit 50 is moved from the retreat position toward the recording position will be described.

As shown in FIG. 15, the main body section 50a of the head unit 50 includes a first sensor 86A and a second sensor 86B on both sides with respect to a central position Yc between a first position Q1 and a second position Q2 in the Y-axis direction. In the Y-axis direction, the distance between the central position Yc and the first sensor 86A, and the distance between the central position Yc and the second sensor 86B, are equal in this embodiment. The first sensor 86A and the second sensor 86B are both optical sensors in the present embodiment.

As shown in FIG. 7, the second rack forming member 62 is provided with a detection target section 62d. Then, the detection target section 62d of the second rack forming member 62, which is provided in the −Y direction, can be switched between a state in which it blocks an optical axis of the first sensor 86A (On state) and a state in which it does not block the optical axis of the first sensor 86A (Off state) in accordance with the relative movement between the main body section 50a and the second rack forming member 62.

Similarly, the detection target section 62d of the second rack forming member 62 provided in the +Y direction can be switched between a state in which it blocks an optical axis of the second sensor 86B (On state) and a state in which it does not block the optical axis of the second sensor 86B (Off state) in accordance with the relative movement between the main body section 50a and the second rack forming member 62.

Thus, the first sensor 86A and the second sensor 86B constitute a detection section 86 for detecting the relative movement between the main body section 50a and the second rack forming member 62.

As described above, the control section 58 that receives detection signals from the first sensor 86A and the second sensor 86B can detect the relative movement between the main body section 50a and the second rack forming member 62.

Next, as shown in FIG. 15, a detection target section 50f is provided on the main body section 50a. In the present embodiment, as shown in FIG. 15, the detection target section 50f is provided at the central position Yc between the first position Q1 and the second position Q2 in the Y-axis direction.

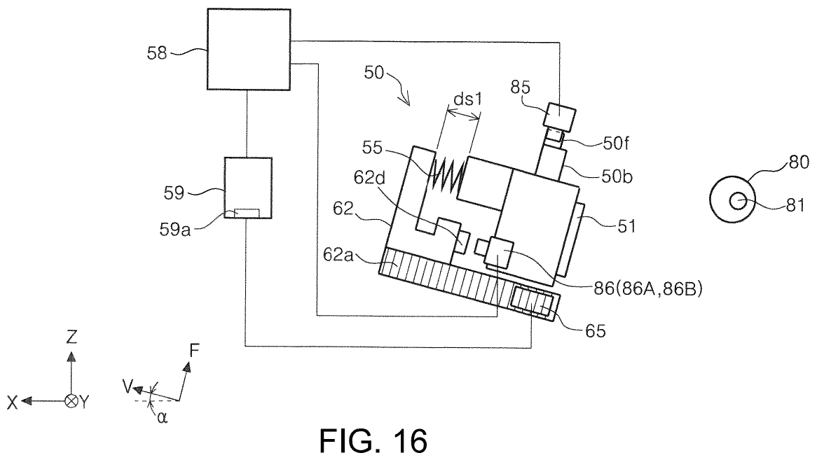

As shown in FIGS. 16 to 18, a home position sensor 85 is provided at a position independent from the head unit 50 in the device main body 2 of the printer 1. Hereinafter, the home position sensor is abbreviated as an “HP sensor”. The HP sensor 85 is an optical sensor in the present embodiment.

The detection target section 50f of the main body section 50a can be switched between a state of blocking an optical axis of the HP sensor 85 (On state) and a state of not blocking the optical axis (Off state) in accordance with the movement of the head unit 50.

As described above, the control section 58 that receives a detection signal from the HP sensor 85 can detect that the head unit 50 is positioned at the home position. In the present embodiment, the home position of the head unit 50 is set to the position V3b as shown in FIG. 10, that is, the position where a flushing operation is performed.

An encoder sensor 59a is provided in the motor 59 that is a driving source when the head unit 50 moves, and the control section 58 can detect a drive amount of the motor 59, in other words, a movement amount of the head unit 50 based on a detection signal from the encoder sensor 59a.

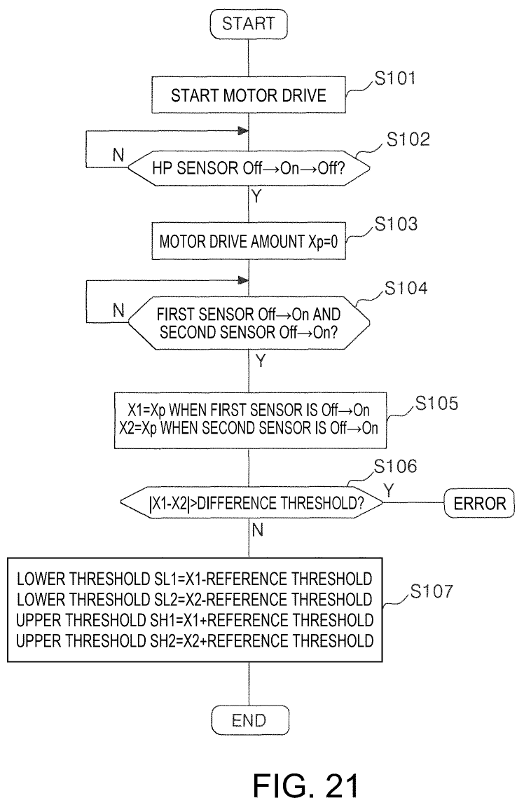

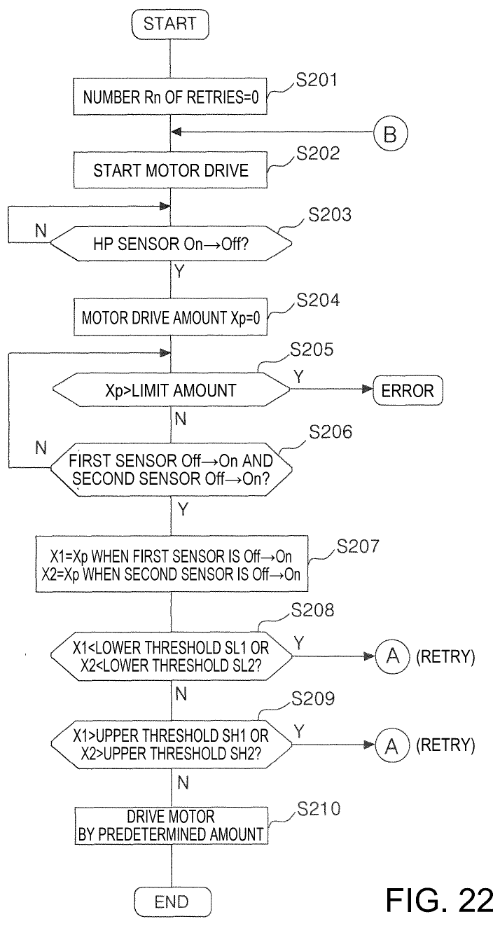

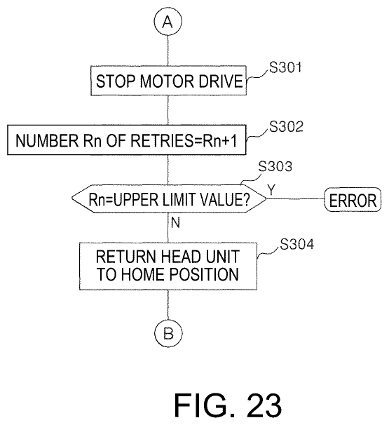

Next, a control when the head unit 50 is removed and attached will be described with reference to FIG. 21. FIG. 21 is a flowchart showing a flow of an initial detection operation when the head unit 50 is replaced. The control after the head unit 50 is mounted will be described later with reference to FIGS. 22 and 23.

The control section 58 determines an inclination of the head unit 50, which will be described below, by executing the control shown in FIG. 21 according to the attachment and detachment of the head unit 50, and acquires lower thresholds SL1 and SL2 and upper thresholds SH1 and SH2. The attachment and detachment of the head unit 50 can be input by an operator via an operation panel (not shown), and the control section 58 can execute the control shown in FIG. 21 based on the input.

When the head unit 50 is removed and attached, the head unit 50 is at the retreat position. In this state, the control section 58 starts driving the motor 59 to move the head unit 50 in the −V direction (step S101), and monitors the state change of the HP sensor 85 (step S102).

When the head unit 50 reaches the home position from the retreat position and further passes through the home position, the HP sensor 85 is switched from the Off state to the On state and further switched to the Off state (Yes in step S102), and the control section 58 sets a variable Xp indicating a drive amount of the motor 59 to a reference value, that is, zero (step S103). Hereinafter, the variable Xp is referred to as a motor drive amount Xp. The motor drive amount Xp can be acquired by the encoder sensor 59a (refer to FIGS. 16 to 18).

Then the control section 58 monitors the state change of the first sensor 86A and the second sensor 86B, when the first sensor 86A and the second sensor 86B are switched from both Off state to On state (Yes in step S104), the control unit 58 sets a value X1 to the motor drive amount Xp when the first sensor 86A switches from the Off state to the On state, and sets a value X2 to the motor drive amount Xp when the second sensor 86B switches from the Off state to the On state (step S105).

Then, the control section 58 determines whether the absolute values of the difference between the value X1 and the value X2 exceeds the difference threshold (step S106). When the absolute value of the difference between the value X1 and the value X2 exceeds the difference threshold, it can be said that a longitudinal direction of the head unit 50 is not along the Y-axis direction and there is a possibility that the head unit 50 is attached in an inclined manner. Therefore, in this case, the control section 58 determines that an inclination error of the head unit 50 has occurred (Yes in step S106). Due to this error, for example, an operator performs attachment and detachment work of the head unit 50 again.

When the absolute value of the difference between the value X1 and the value X2 is equal to or less than the difference threshold (No in step S106), the control section 58 acquires the lower threshold SL1 by value X1−reference threshold, acquires the lower threshold SL2 by value X2−reference threshold, acquires the upper threshold SH1 by value X1+reference threshold, and acquires the upper threshold SH2 by value X2+reference threshold (step S107). The lower thresholds SL1 and SL2 and the upper thresholds SH1 and SH2 will be described later.

The difference threshold and the reference threshold described above are stored in advance in a storage unit (not shown) included in the control section 58. The lower thresholds SL1 and SL2 and the upper thresholds SH1 and SH2 are stored in a storage unit (not shown) included in the control section 58.

A program for realizing the control described with reference to FIG. 21 is stored in advance in a storage unit (not shown) included in the control section 58.

Next, a control for moving the head unit 50 from the home position to the recording position among controls in a state where the head unit 50 is mounted will be described with reference to FIG. 22 and other drawings as appropriate.

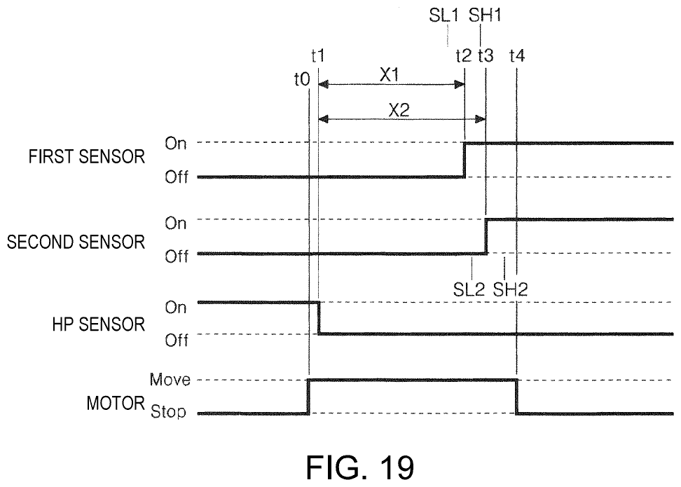

First, the control section 58 sets a variable Rn, which indicates the number of retries, to zero (step S201). Next, the control section 58 starts the driving of the motor 59 and moves the head unit 50 in the −V direction, that is, toward the recording position (step S202, timing to in FIG. 19). FIG. 16 shows a state at the time of starting the driving of the motor 59, and in this state, the HP sensor 85 is in the On state, and the first sensor 86A and the second sensor 86B are in the Off state. The spring length of the spring 55 is at its maximum, and a length ds1 indicates the spring length at this time.

The control section 58 monitors the state change of the HP sensor 85, and when the HP sensor 85 switches from the On state to the Off state (Yes in step S203, timing t1 in FIG. 19), sets the motor drive amount Xp to a reference value, that is, zero (step S204).

Thereafter, the control section 58 drives the motor 59 until both the first sensor 86A and the second sensor 86B are switched from the Off state to the On state (Yes in step S206). If the first sensor 86A and the second sensor 86B do not switch from the Off state to the On state even if the motor drive amount Xp exceeds a predetermined limit amount in this process (Yes in step S205), the control section 58 performs an error process as an abnormality has occurred. As part of this error process, for example, stopping the drive of motor 59 and performing a notification on an operation panel (not shown) that an abnormality has occurred can be mentioned.

FIG. 17 shows a state when the cam contact surface 50b of the main body section 50a abuts against the adjustment cam 80. In this state, the spring length of spring 55 remains at the length ds1. The first sensor 86A and the second sensor 86B are both in the Off state.

When the motor 59 is further driven from this state, the second rack forming member 62 moves in the −V direction while the main body section 50a remains stopped. When the second rack forming member 62 moves in the −V direction in a state where the main body section 50a is stopped, the spring lengths of the spring 55 becomes a length ds2 shorter than the length ds1 as shown in FIG. 18, and the first sensor 86A and the second sensor 86B switch from the Off state to the On state. However, as shown in FIG. 19, there may be a deviation between a timing t2 when the first sensor 86A switches from the Off state to the On state and a timing t3 when the second sensor 86B switches from the Off state to the On state.

When both the first sensor 86A and the second sensor 86B switch from the Off state to the On state (Yes in step S206, timing t3 in FIG. 19), the control section 58 sets the value X1 to the motor drive amount Xp when the first sensor 86A switches from the Off state to the On state, and sets the value X2 to the motor drive amount Xp when the second sensor 86B switches from the Off state to the On state (step S207).

Next, control section 58 determines whether the value X1 is less than the lower threshold SL1 or the value X2 is less than the lower threshold SL2, and when the value X1 is less than the lower threshold SL1 or the value X2 is less than the lower threshold SL2 (Yes in step S208), the control section 58 performs a retry operation. The retry operation is performed based on a determination process shown in FIG. 23 (to be described later).

The control section 58 determines whether the value X1 exceeds the upper threshold SH1, or whether the value X2 exceeds the upper threshold SH2, and when the value X1 exceeds the upper threshold SH1, or the value X2 exceeds the upper threshold SH2 (Yes in step S209), the control section 58 performs a retry operation. The retry operation is performed based on a determination process shown in FIG. 23 (to be described later).

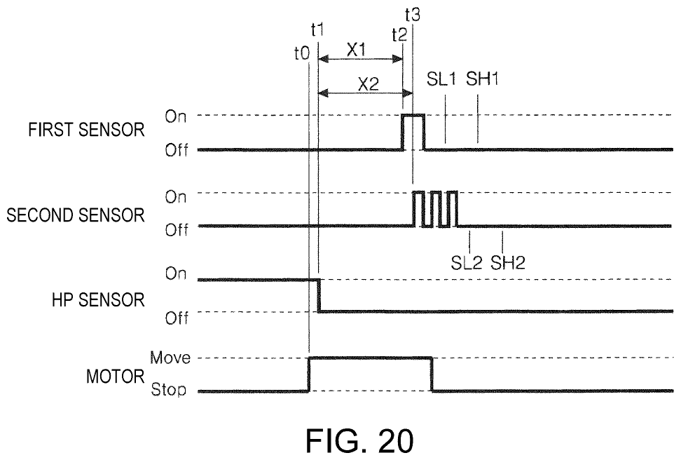

The timing chart shown in FIG. 20 shows an example in which the value X1 is less than the lower threshold SL1 and the value X2 is less than the lower threshold SL2. In such a case, it can be determined that the relative movement between the main body section 50a and the second rack forming member 62 is caused by a factor other than an abutment between the cam contact surface 50b of the main body section 50a and the adjustment cam 80, for example, an external disturbance. In such a case, even if the motor 59 is driven as it is, it can be determined that there is a possibility that the cam contact surface 50b of the main body section 50a does not appropriately abut on the adjustment cam 80, and therefore a retry operation is performed as described later or an error process is performed. Incidentally, when the first sensor 86A or the second sensor 86B switches a plurality of times from the Off state to the On state below the lower threshold, the control unit 58 uses the initial switching from the Off state to the On state (step S208).

Although not shown in the timing chart, when the value X1 exceeds the upper threshold SH1 or the value X2 exceeds the upper threshold SH2, it can be determined that some abnormality has occurred, and therefore a retry operation is performed or error processing is performed as described later.

Returning to FIG. 22, in a case of No in step S208 and step S209, the control unit 58 can determine that the cam contact surface 50b of the main body section 50a appropriately comes into contact with the adjustment cam 80. In this case, the process proceeds to step S210, and the motor 59 is driven by a predetermined amount. By driving the motor 59 by the predetermined amount, the second rack forming member 62 is further pressed in the −V direction. As a result, due to a spring force of the spring 55, the cam contact surface 50b of the main body section 50a is more reliably pressed against the adjustment cam 80.

In a case of Yes in step S208 or step S209 in FIG. 22, the processing moves to position A in FIG. 23. FIG. 23 is a processing determination when performing the retry operation, the control section 58 driving the motor 59 (step S301), increments the variable Rn indicating the number of retries (step S302), and then determines whether the variable Rn has reached the upper limit value (step S303). When the variable Rn reaches the upper limit value (Yes in step S303), an error process is performed. This error process includes performing a notification that an abnormality has occurred on an operation panel (not shown).

When the variable Rn does not reach the upper limit value (No in step S303), the head unit 50 is returned to the home position (step S304). Then, the process moves to position B in FIG. 22, and the step S202 and the subsequent steps are performed again.

The above-described limit amount (step S205 in FIG. 22), the predetermined amount (step S210 in FIG. 22), and the upper limit value (step S303 in FIG. 23) are stored in advance in a storage unit (not shown) included in the control section 58.

A program for realizing the control described with reference to FIG. 22 and FIG. 23 is stored in advance in a storage unit (not shown) included in the control section 58.

Next, the pressing unit 70 that applies the pressing force F4 to the head unit 50 in a direction that cancels the moment Ma described with reference to FIG. 12 will be described.

In the present embodiment, the pressing unit 70 is provided in the vicinity of an end section of the head unit 50 in the −Y direction in the Y-axis direction as shown in FIG. 15.

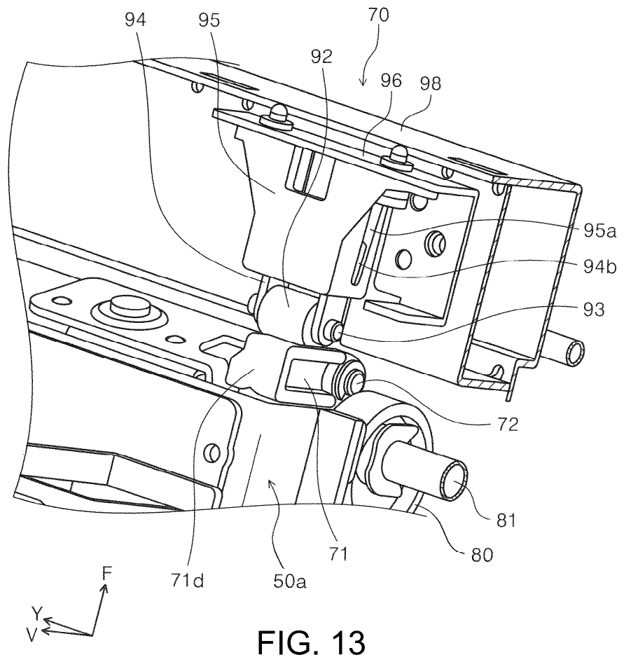

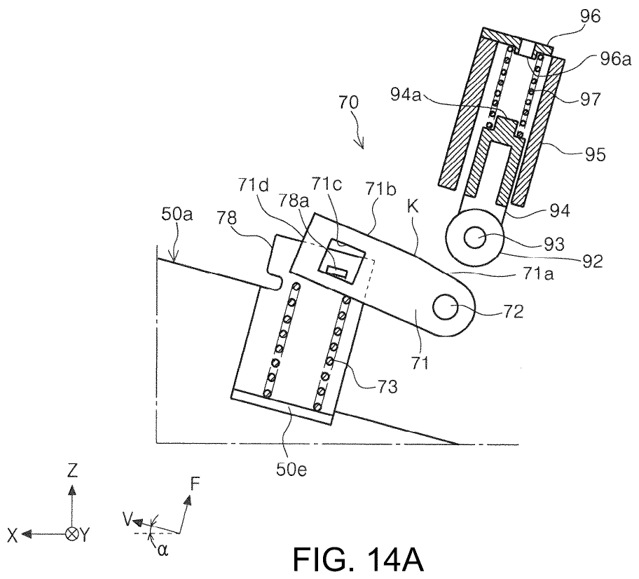

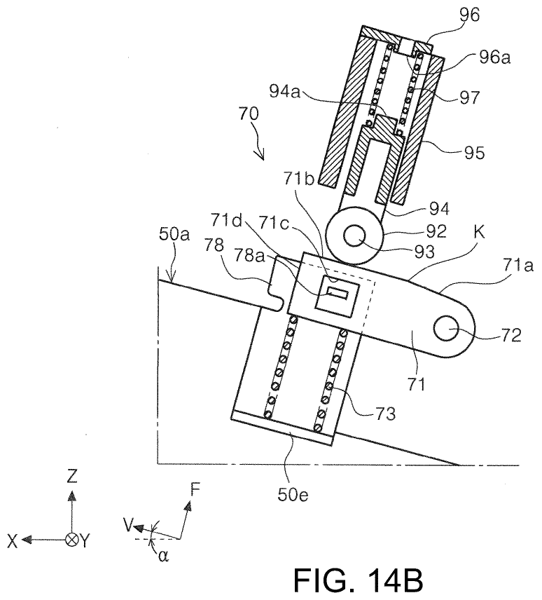

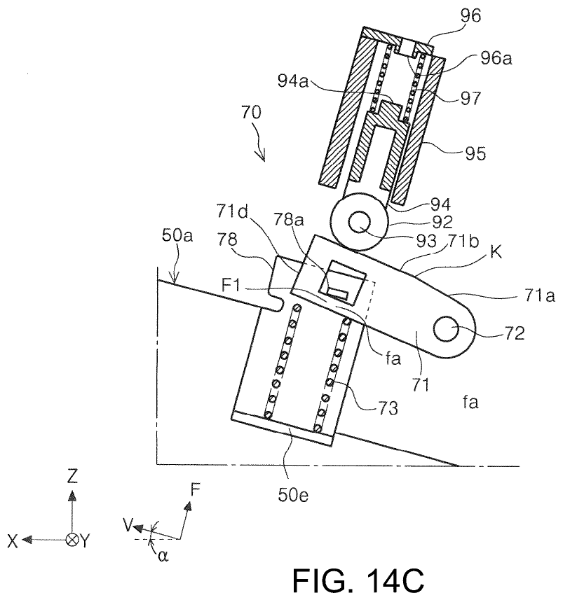

In FIG. 13, the pressing unit 70 includes a driven roller 92, which is an example of a first advancing and retreating member, a first pressing member 97 (refer to FIG. 14A), a rotation member 71, which is an example of a second advancing and retreating member, and a second pressing member 73 (refer to FIG. 14A).

The driven roller 92 and the first pressing member 97 are members provided independently of the head unit 50. The rotation member 71 and the second pressing member 73 are members provided in the main body section 50a of the head unit 50.

The driven roller 92 is rotatably provided to a support member 94 via a rotation shaft 93. An axis center line of the rotation shaft 93 is along the Y-axis direction. The support member 94 is held by a holding member 95 so as to be displaceable along the F-axis direction. The holding member 95 includes a guide groove 95a (refer to FIG. 13) formed along the F-axis direction. A guided section 94b (refer to FIG. 13) is formed on the support member 94, and the guided section 94b enters the guide groove 95a and is guided in the F-axis direction. The displacement in the −F direction of the guided section 94b is restricted by an end section of the guide groove 95a in the −F direction. As described above, the driven roller 92 is provided so as to be able to advance and retreat with respect to the head unit 50.

As shown in FIG. 14A, the first pressing member 97 is provided inside the holding member 95. In the present embodiment, the first pressing member 97 is a compression coil spring.

As shown in FIG. 13, the holding member 95 is attached to a spring receiving frame 96, and the spring receiving frame 96 is attached to an attachment frame 98. On a lower side of the spring receiving frame 96, a protrusion 96a is formed as shown in FIG. 14A, and the first pressing member 97 is held in position by the protrusion 96a and a protrusion 94a formed on an upper section of the support member 94.

The first pressing member 97 presses the support member 94, that is, the driven roller 92 in the −F direction toward the rotation member 71 (to be described later). In the present embodiment, the first pressing member 97 is a compression coil spring, but as long as it can press the driven roller 92 in the −F direction, it is not limited to a compression coil spring and may be a tension coil spring, a torsion coil spring, or the like.

Next, in FIGS. 13 and 14A, the rotation member 71 is provided in the main body section 50a so as to be rotatable about a rotation shaft 72. An axis center line of the rotation shaft 72 is along the Y-axis direction, and a free end 71d is positioned in the +V direction with respect to the rotation shaft 72.

The second pressing member 73 is provided on a lower side of the rotation member 71 as shown in FIG. 14A, and the free end 71d of the rotation member 71 presses the rotation member 71 in a direction away from the head unit 50 (+F direction). A pressing force of the second pressing member 73 presses the rotation member 71 in a clockwise direction in FIG. 14A. In the present embodiment, the second pressing member 73 is a compression coil spring, but as long as it can press the rotation member 71 in the clockwise direction in FIG. 14A, it is not limited to a compression coil spring and may be a tension coil spring, a torsion coil spring, or the like.

The main body section 50a is provided with a rotation restriction member 78. The rotation restriction member 78 is provided with a protrusion-shaped rotation restriction section 78a, and the rotation restriction section 78a enters a window hole 71c formed in the rotation member 71. By this, in a state where the rotation member 71 is separated from the driven roller 92, a lower edge of the window hole 71c as shown in FIG. 14A abuts against the rotation restriction section 78a, and a clockwise direction rotation of the rotation member 71 in FIG. 14A is restricted.

When the head unit 50 moves toward the recording position from this state, the rotation member 71 abuts against the driven roller 92 and rotates in a counterclockwise direction as shown by the change from FIG. 14A to FIG. 14B. By this, the second pressing member 73 is contracted, and a pressing force of the second pressing member 73 acts on the spring receiving section 50e that receives the second pressing member 73. This pressing force becomes the pressing force F4 shown in FIG. 12.

A pressing force of the second pressing member 73 counters the lifting force R2 and is set to a magnitude that prevents the second guided roller 52B from lifting up from the second guide surface S2.

In the present embodiment, spring constants of the first pressing member 97 and the second pressing member 73 are different. Specifically, in the present embodiment, as shown in FIG. 14B, in a state where the head unit 50 is moved to the recording position, a pressing force with which the driven roller 92 presses the rotation member 71 in the −F direction is greater than a pressing force with which the rotation member 71 presses the driven roller 92 in the +F direction.

As described above, the printer 1 includes the pressing unit 70 that applies the pressing force F4 (refer to FIG. 12) to head unit 50 in a direction that cancels the rotation of the head unit 50, that is, the moment Ma (refer to FIG. 12), when the head unit 50 is at the recording position. By the pressing force F4 from the pressing unit 70, the second guided roller 52B is pressed against the second guide surface S2 regardless of the lifting force R2. By this, it is possible to suppress the posture of the head unit 50 from becoming unstable due to the moment Ma, and it is possible to obtain favorable recording quality. This is referred to as a first operation and effect of the pressing unit 70.

Since the pressing unit 70 attempts to cancel the rotation of the head unit 50 by pressing the head unit 50 in a direction intersecting the movement direction of the head unit 50, it is possible to prevent the pressing unit 70 from hindering the movement of the head unit 50 along the V-axis direction. As a result, it is possible to suppress an increase in cost and an increase in power consumption due to an increase in rated output of the motor 59 (refer to FIG. 4), which is a power source for movement of the head unit 50.

In the present embodiment, a pressing direction of the head unit 50 by the pressing unit 70 is the −F direction, which is a direction orthogonal to the V-axis direction, which is the movement direction of the head unit 50, but the pressing direction is not limited to this, and may be a direction intersecting the V-axis direction, which is the movement direction of the head unit 50.

The head unit 50 is provided with the first guided roller 52A at a one-side end section (+Y-axis direction end section) in the Y-axis direction, and at an other-side end section ( −Y-axis direction end section) in the Y-axis direction, the head unit 50 is provided with the second guided roller 52B and the third guided roller 52C spaced apart in the movement direction of the head unit 50. The first guided roller 52A is guided in the movement direction of the head unit 50 while being supported by first guide surfaces S1-1 and S1-2 (refer to FIG. 9) extending along the movement direction, and the second guided roller 52B and the third guided roller 52C are guided in the movement direction while being supported by the second guide (refer to FIG. 8) extending along the movement direction. The head unit 50 is supported at three positions by the first guided roller 52A, the second guided roller 52B, and the third guided roller 52C when the head unit 50 is at least at the recording position. As a result, the posture of the head unit 50 at the recording position is stabilized, and favorable recording quality can be obtained.

In FIG. 15, reference symbol Q1 denotes the first position at which the first guided roller 52A is in contact with the first guide surface S1-1, reference symbol Q2 denotes the second position at which the second guided roller 52B is in contact with the second guide surface S2, and reference symbol Q3 denotes a third position at which the third guided roller 52C is in contact with the second guide surface S2. Reference symbol Q4 denotes a fourth position at which the pressing unit 70 applies the pressing force F4 to the head unit 50. In the present embodiment, when viewed from a direction (+F direction) orthogonal to a plane including the first position Q1, the second position Q2, and the third position Q3, the fourth position Q4 is positioned inside a triangular region At connecting the first position Q1, the second position Q2, and the third position Q3.

By this, the first guided roller 52A is appropriately pressed against the first guide surface S1-1, the second guided roller 52B is appropriately pressed against the second guide surface S2, and the third guided roller 52C is appropriately pressed against the second guide surface S2. As a result, the posture of the head unit 50 is stabilized, and favorable recording quality can be obtained.

However, the fourth position Q4 may be on the outer edge

of the region At or may be outside the region At.

In FIG. 15, reference symbol Q5 denotes a gravity center position of the head unit 50 when viewed from a direction (+F direction) orthogonal to the plane including the first position Q1, the second position Q2, and the third position Q3. The gravity center position Q5 is inside the triangular region At connecting the first position Q1, the second position Q2, and the third position Q3. This stabilizes the posture of the head unit 50.

As described above, the second guided roller 52B is positioned at a position where it is lifted from the second guide surface S2 by the rotation of the head unit 50 caused by the moment Ma, and the third guided roller 52C is positioned at a position where it is pressed against the second guide surface S2 by the rotation of the head unit 50 caused by the moment Ma. The fourth position Q4 at which the pressing unit 70 applies the pressing force F4 to the head unit 50 is on a side of the second position Q2 with respect to the central position Yc between the first position Q1 and the second position Q2 in the Y-axis direction. The fourth position Q4 is positioned on a side of the second position Q2 with respect to a central position Vc between the second position Q2 and the third position Q3 in the V-axis direction.

By this, the head unit 50 is pressed at a position close to the second guided roller 52B, and the rotation of the head unit 50 is appropriately suppressed.

However, the fourth position Q4 may be positioned at the central position Yc in the Y-axis direction or on a side of the first position Q1 with respect to the central position Yc, and may be positioned at the central position Vc in the V-axis direction or on a side of the third position Q3 with respect to the central position Vc.

The axis center line of the rotation shaft 72 of the rotation member 71 is along the Y-axis direction, and the free end 71d in the V-axis direction is in the +V direction with respect to the rotation shaft 72, that is, on a side of the retreat position. When the head unit 50 moves from the retreat position to the recording position, the driven roller 92 moves relatively to the rotation member 71 from the rotation shaft 72 toward the free end 71d. By this, when the head unit 50 moves from the retreat position to the recording position, the force applied to the head unit 50 by the pressing unit 70 gradually increases. That is, a sudden large load is prevented from being applied when the head unit 50 moves to the recording position, and the head unit 50 can move to the recording position smoothly.

As shown in FIGS. 14A and 14B, a surface of the rotation member 71 that comes into contact with the driven roller 92 is composed of a first contact surface 71a and a second contact surface 71b, which forms a predetermined angle with the first contact surface 71a, and the first contact surface 71a is the initial point of contact with the driven roller 92 when the head unit 50 moves to the recording position. When switching from a state of FIG. 14A to a state of FIG. 14B, the first contact surface 71a functions to guide the driven roller 92 to the second contact surface 71b, allowing the head unit 50 to move more smoothly to the recording position.

The pressing unit 70 includes the rotation restriction section 78a for restricting the rotation of the rotation member 71 in a direction in which the free end 71d of the rotation member 71 is away from the head unit 50. By this, it is possible to reduce a contact angle when the driven roller 92 comes into contact with the rotation member 71, and it is possible to further prevent a large load from being suddenly applied when the head unit 50 moves to the recording position.

In the present embodiment, since the first advancing and retreating member that is in contact with the rotation member 71 is the driven roller 92, a load applied to the rotation member 71 is reduced, but instead of the driven roller 92, another non-rotating member may be used as the first advancing and retreating member.

The pressing unit 70 includes the driven roller 92 that is provided independently of the head unit 50 and can advance and retreat with respect to the head unit 50, and the first pressing member 97 that is provided independently of the head unit 50 and presses the driven roller 92 toward the head unit 50. Therefore, compared to a configuration in which the driven roller 92 is fixed and does not advance or retreat, a load when the head unit 50 moves in the −V direction can be reduced, and the head unit 50 can be appropriately moved to the positioning position. This is referred to as a second operation and effect of the pressing unit 70.

In particular, in a case where the driven roller 92 is fixedly provided, when the head unit 50 moves toward the recording position, if the driven roller 92 comes into contact with the vicinity of the rotation shaft 72 of the rotation member 71, the rotation member 71 cannot retreat in the −F direction. For this reason, the main body section 50a cannot move further in the −V direction, and the cam contact surface 50b of the main body section 50a may not appropriately come into contact with the adjustment cam 80.

In the present embodiment, as described with reference to FIG. 15, the fourth position Q4 at which the pressing unit 70 applies the pressing force F4 to the main body section 50a is positioned on a side of the second position Q2 with respect to the central position Yc between the first position Q1 and the second position Q2 in the Y-axis direction. For this reason, when the driven roller 92 hinders the movement of the main body section 50a in the −V direction, an end section of the main body section 50a in the +Y direction moves first in the −V direction, and the main body section 50a is inclined in a Y-V plane. This may be detectable by the value X1 being less than the lower threshold SL1 in step S208 shown in FIG. 22. However, even when the value X1 is between the lower threshold SL1 and the upper threshold SH1, the cam contact surface 50b of the main body section 50a may not be able to appropriately contact the adjustment cam 80. This can also be referred to as erroneous detection of the first sensor 86A. In this case, the line head 51 does not take an appropriate position and posture, and consequently, and a gap between the ink ejection surface 51a and the transport belt 13 becomes inappropriate, leading to a decline in recording quality.

However, as described above, since the driven roller 92 can advance and retreat with respect to the head unit 50, even when the driven roller 92 comes into contact with the vicinity of the rotation shaft 72 of the rotation member 71, the driven roller 92 moves in the +F direction, so that the main body section 50a can appropriately move in the −V direction, and thus the cam contact surface 50b of the main body section 50a can appropriately come into contact with the adjustment cam 80. As a result, the line head 51 is in an appropriate position and posture, and a gap between the ink ejection surface 51a and the transport belt 13 is suitable, allowing for favorable recording quality to be achieved. It is possible to suppress erroneous detection of the first sensor 86A.

Since the impact when the rotation member 71 comes into contact with the driven roller 92 is alleviated, it is also possible to suppress damage to meniscus of a nozzle that ejects ink.

In the present embodiment, the head unit 50 includes the main body section 50a that is provided with the recording head, and the second rack forming member 62 that is slidable relative to the main body section 50a along the V-axis direction. The movement mechanism 60 moves the second rack forming member 62 in the −V direction in a state where the main body section 50a is in contact with the adjustment cam 80, thereby pressing the main body section 50a in the −V direction. By this, it is possible to improve the positioning accuracy of the line head 51.

By pressing the main body section 50a in the −V direction, a reaction force that the main body section 50a receives from the adjustment cam 80 increases, and the moment Ma shown in FIG. 12 increases, but the moment Ma can be suitably suppressed by the first operation and effect of the pressing unit 70 described above.

In the present embodiment, the head unit 50 includes the first receiving section 62c provided on the second rack forming member 62, the second receiving section 50c provided on the main body section 50a, and the spring 55, which is a pressing member provided between the first receiving section 62c and the second receiving section 50c, and is the third pressing member for pressing the second receiving section 50c in the −V direction when the second rack forming member 62 moves in the −V direction in a state where the main body section 50a abuts on the adjustment cam 80.

With such a configuration, a position of the main body section 50a, that is, the line head 51, is stabilized by the spring 55, and appropriate recording quality is obtained.

In the present embodiment, the printer 1 includes the detection section 86, which detects the relative displacement between the second rack forming member 62 and the main body section 50a when the head unit 50 moves in the −V direction.

When the head unit 50 moves in the −V direction and the second rack forming member 62 and the main body section 50a are relatively displaced, the following first case and second case can be considered. The first case is a case where the cam contact surface 50b of the main body section 50a appropriately comes into contact with the adjustment cam 80. The second case is a case where the movement of the main body section 50a in the −V direction is inhibited by a pressing force of the pressing unit 70 before the cam contact surface 50b of the main body section 50a appropriately comes into contact with the adjustment cam 80, and the main body section 50a stops before the cam contact surface 50b of the main body section 50a comes into contact with the adjustment cam 80.

The detection section 86, including the first sensor 86A and the second sensor 86B, can detect that the cam contact surface 50b of the main body section 50a appropriately comes into contact with the adjustment cam 80 by detecting the first case. In the second case, since the occurrence can be suppressed by the second operation and effect of the pressing unit 70 described above, it is possible to detect that the main body section 50a is appropriately abutted against the adjustment cam 80 by the detection section 86.

The movement mechanism 60 moves the head unit 50 in the movement direction by a rack and pinion mechanism, and the second rack 62a, which is a rack constituting the rack and pinion mechanism, is provided on the second rack forming member 62. In this way, the rack and pinion mechanism allows the head unit 50 to be moved with a simple structure.

By the operation and effect of the pressing unit 70 described above, the detection section 86, which includes the first sensor 86A and the second sensor 86B, can appropriately detect that the main body section 50a appropriately comes into contact with the adjustment cam 80.

In the present embodiment, both the first pressing member 97 and the second pressing member 73 are springs, and a spring constant of the first pressing member 97 is different from a spring constant of the second pressing member 73.

By this, when the driven roller 92 and the rotation member 71 are engaged with each other, a member pressed by a member having a relatively smaller spring constant can be easily retreated. As a result, a load applied when the head unit 50 moves in the −V direction can be appropriately suppressed, and the head unit 50 can be more appropriately moved to the positioning position.

In this case, the force F4 (refer to FIG. 12) for pressing the head unit 50 so as to cancel the moment Ma (refer to FIG. 12) in a state where a part of the head unit 50 abuts against the adjustment cam 80 is obtained by contraction of a spring having a relatively smaller spring constant. By this, variations in the force F4 can be suppressed, and the appropriate force F4 can be easily obtained.

Even if the rotation member 71 pressed by a spring having a relatively smaller spring constant cannot temporarily retreat when the rotation member 71 abuts against the driven roller 92 in a process of moving the head unit 50 toward the recording position, the head unit 50 can appropriately move to the recording position because the driven roller 92 pressed by a spring having a relatively larger spring constant temporarily retreats. An example of a case where the rotation member 71 cannot be temporarily retreated is a case where the driven roller 92 comes into contact with the vicinity of the rotation shaft 72 of the rotation member 71 as described above.

In the present embodiment, as described above, in a state where the head unit 50 is moved to the recording position as shown in FIG. 14B, a pressing force that the driven roller 92 presses the rotation member 71 in the −F direction is configured to exceed a pressing force that the rotation member 71 presses the driven roller 92 in the +F direction.

With such a configuration, a pressing force with which the rotation member 71 presses the driven roller 92 in the +F direction is set based on the force F4 shown in FIG. 12. Even in a case where the rotation member 71 abuts against the driven roller 92 in a state where the rotation member 71 cannot be retreated in the −F direction in a process in which the head unit 50 moves toward the recording position, the driven roller 92 having a relatively large pressing force is temporarily retreated, and thus the head unit 50 can appropriately move to the recording position. An example of a case where the rotation member 71 cannot be temporarily retreated is a case where the driven roller 92 comes into contact with the vicinity of the rotation shaft 72 of the rotation member 71 as described above.

In a state where the head unit 50 is moved to the recording position, the rotation member 71 having a relatively small pressing force moves in the −F direction, and thus it is possible to easily obtain an appropriate force F4.

However, the present disclosure is not limited thereto, and as shown in FIG. 14C, in a state where the head unit 50 is moved to the recording position, a pressing force with which the driven roller 92 presses the rotation member 71 in the −F direction may be lower than a pressing force with which the rotation member 71 presses the driven roller 92 in the +F direction.

However, in a configuration in which the rotation member 71 includes the first contact surface 71a and the second contact surface 71b as in the present embodiment, in a case shown in FIG. 14B, the driven roller 92 can press the second contact surface 71b straight in the −F direction. By this, it is possible to suppress a force with which the driven roller 92 presses the head unit 50 from acting to hinder the movement of the head unit 50.

In the present embodiment, the second advancing and retreating member is the rotation member 71, which is rotatable and advances and retreats with respect to the first pressing member 97 by rotating. When the rotation member 71 rotates, the free end 71d is positioned in the +V direction with respect to the rotation shaft 72. When the head unit 50 moves in the −V direction, the driven roller 92 moves relative to the rotation member 71 from the rotation shaft 72 toward the free end 71d. By this, a pressing force applied to the head unit 50 by the pressing unit 70 is gradually increased, and it is possible to prevent a sudden load from being applied to the head unit 50.

In the embodiment described above, the rotation member 71 is provided in the head unit 50, and the driven roller 92 is provided at a position independent from the head unit 50, but the reverse may be possible.

In the present embodiment, the second advancing and retreating member is the rotation member 71, which is capable of rotating and advances and retreats with respect to the first pressing member 97 by rotating, but the second advancing and retreating member may also be a member that advances and retreats with respect to the first pressing member 97 without rotating.

Although one first pressing member 97 for pressing the driven roller 92 is provided in the above-described embodiment, a plurality of first pressing members 97 may be provided so as to surround the protrusions 94a and 96a (refer to FIG. 14A) in the Y-V plane.

In the present embodiment, the positioning section that determines a position of the head unit 50 is the adjustment cam 80, which is a cam section that defines a distance between the head unit 50 and a medium, and the positioning position is the recording position. By this, an appropriate recording result is obtained.

However, the positioning section may be the cap member 46 as a maintenance section, and the positioning position may be a cap position. Thus, a favorable maintenance result is obtained.

The present disclosure is not limited to the embodiments described above, and various modifications are possible within the scope of the application described in the claims, and it goes without saying that these are also included within the scope of the present disclosure.

What is claimed is:

1. A recording device comprising:
a recording section that records on a medium;
a movement mechanism that moves the recording section along a movement direction between a recording position where the recording section records on a medium and a retreat position where the recording section is retreated from the recording position;
a positioning section that abuts against a part of the recording section moving in a first direction, and that determines a position of the recording section in the movement direction as a positioning position, assuming that one of a direction from the retreat position toward the recording position and a direction from the recording position toward the retreat position in the movement direction is the first direction and an opposite direction is a second direction; and
a pressing unit that, in a state where a part of the recording section is in contact with the positioning section, presses the recording section so as to cancel moment generated in the recording section by force received from the positioning section and the movement mechanism, wherein
the pressing unit includes
a first advancing and retreating member that is provided independently of the recording section and that is configured to advance and retreat with respect to the recording section,
a first pressing member that is provided independently of the recording section and that presses the first advancing and retreating member toward the recording section,
a second advancing and retreating member that is provided in the recording section and that is configured to advance and retreat with respect to the first advancing and retreating member, and
a second pressing member that is provided in the recording section and that presses the second advancing and retreating member toward the first advancing and retreating member.

2. The recording device according to claim 1, wherein
the recording section includes
a main body section including a recording head and
a slide member configured to slide relatively with respect to the main body section along the movement direction and
the movement mechanism presses the main body section in the first direction by moving the slide member in the first direction in a state where the main body section is in contact with the positioning section.

3. The recording device according to claim 2, wherein
the recording section includes
a first receiving section provided on the slide member,
a second receiving section provided on the main body section, and
a third pressing member that is provided between the first receiving section and the second receiving section and that presses the second receiving section in the first direction when the slide member moves in the first direction in a state where the main body section is in contact with the positioning section.

4. The recording device according to claim 2, further comprising:
a detection section that detects relative displacement between the slide member and the main body section when the recording section moves in the first direction.

5. The recording device according to claim 2, wherein
the movement mechanism moves the recording section in the movement direction by a rack and pinion mechanism and a rack that constitutes the rack and pinion mechanism is provided in the slide member.

6. The recording device according to claim 4, wherein
the movement mechanism moves the recording section in the movement direction by a rack and pinion mechanism,
a rack that constitutes the rack and pinion mechanism is provided in the slide member, and
the detection section detects relative movement between the main body section and the slide member.

7. The recording device according to claim 1, wherein
the first pressing member and the second pressing member are both springs and
a spring constant of the first pressing member is different from a spring constant of the second pressing member.

8. The recording device according to claim 1, wherein
the second advancing and retreating member is configured to rotate and advances and retreats with respect to the first advancing and retreating member by rotating,
an axis center line of a rotation shaft of the second advancing and retreating member is along a width direction intersecting the movement direction,
a free end when the second advancing and retreating member rotates is positioned in the second direction with respect to the rotation shaft, and
when the recording section moves in the first direction, the first advancing and retreating member relatively moves from the rotation shaft toward the free end with respect to the second advancing and retreating member.

9. The recording device according to claim 1, wherein
the recording section includes a first guided section at a one-side end section in a width direction intersecting the movement direction, and a second guided section and a third guided section at an other-side end section in the width direction with a gap therebetween in the movement direction,
the first guided section is guided in the movement direction by a first guide section extending along the movement direction,
the second guided section and the third guided section are guided in the movement direction by a second guide section extending along the movement direction, and
the recording section is supported at three positions of the first guided section, the second guided section, and the third guided section in a state where the recording section is at least at the positioning position.

10. The recording device according to claim 9, wherein
when viewed from a direction orthogonal to a plane including a first position at which the first guided section is in contact with the first guide section, a second position at which the second guided section is in contact with the second guide section, and a third position at which the third guided section is in contact with the second guide section, a position at which the pressing unit applies force to the recording section is within a triangular region connecting the first position, the second position, and the third position.

11. The recording device according to claim 10, wherein
the second guided section is positioned at a position where the second guided section is about to be lifted up from the second guide section by the moment,
the third guided section is positioned at a position where the third guided section is pressed against the second guide section by the moment, and
a position at which the pressing unit applies force to the recording section is on a side of the second position with respect to a central position between the first position and the second position in the width direction, and is on a side of the second position with respect to a central position between the second position and the third position in the movement direction.

12. The recording device according to claim 1, wherein
the positioning section is a cam section that defines a distance between the recording section and a medium and
the positioning position is the recording position.

13. The recording device according to claim 1, further comprising:
a maintenance section that performs maintenance of the recording section, wherein
a movement region of the recording section includes a maintenance position at which maintenance of the recording section is performed,
the positioning section is the maintenance section, and
the positioning position is the maintenance position.

14. The recording device according to claim 1, wherein
the movement direction is a direction intersecting vertical direction and a horizontal direction.
